(19) United States
(12) Patent Application Publication
(10) Pub. No.: US 2017/0083331 A1
(43) Pub. Date: Mar. 23, 2017

(54) MEMORY SYNCHRONIZATION IN BLOCK-BASED PROCESSORS

(71) Applicant: Microsoft Technology Licensing, LLC, Redmond, WA (US)

(72) Inventors: Douglas C. Burger, Bellevue, WA (US); Aaron L. Smith, Seattle, WA (US)

(73) Assignee: Microsoft Technology Licensing, LLC, Redmond, WA (US)

(21) Appl. No.: 15/072,031

(22) Filed: Mar. 16, 2016

Related U.S. Application Data
(60) Provisional application No. 62/221,003, filed on Sep. 19, 2015.

(51) Int. Cl. G06F 9/30; G06F 12/08

(52) U.S. Cl. CPC G06F 9/30043; G06F 12/0875; G06F 2212/452

(57) ABSTRACT

Apparatus and methods are disclosed for performing memory operations instructions in a block-based processor architecture. In certain examples of the disclosed technology, a block-based processor core coupled to memory includes a control unit configured to issue one or more memory operations encoded in an instruction block allocated to the core and to commit the core when execution of the instruction block is complete, a memory store queue configured to cache one or more operands for the one or more memory operations, where a result of performing the memory operations is not architecturally visible unless the instruction block is committed by the control unit, and a memory interface configured to store the cached operands in the memory responsive to the instruction block committing. In some examples, the block-based processor core supports memory synchronization using load linked and store conditional instructions.

### CROSS-REFERENCE TO RELATED APPLICATIONS

This application claims the benefit of U.S. Provisional Patent Application No. 62/221,003, entitled “BLOCK-BASED PROCESSORS,” filed Sep. 19, 2015, which application is incorporated herein by reference in its entirety.

### BACKGROUND

Microprocessors have benefitted from continuing gains in transistor count, integrated circuit cost, manufacturing capital, clock frequency, and energy efficiency due to continued transistor scaling predicted by Moore's law, with little change in associated processor Instruction Set Architectures (ISAs). However, the benefits realized from photolithographic scaling, which drove the semiconductor industry over the last 40 years, are slowing or even reversing. Reduced Instruction Set Computing (RISC) architectures have been the dominant paradigm in processor design for many years. Out-of-order superscalar implementations have not exhibited sustained improvement in area or performance. Accordingly, there is ample opportunity for improvements in processor ISAs to extend performance improvements.

### SUMMARY

Methods, apparatus, and computer-readable storage devices are disclosed for configuring, operating, and compiling code for, block-based processor architectures (BB-ISAs), including explicit data graph execution (EDGE) architectures. The described techniques and tools for solutions for, e.g., improving processor performance and/or reducing energy consumption can be implemented separately, or in various combinations with each other. As will be described more fully below, the described techniques and tools can be implemented in a digital signal processor, microprocessor, application-specific integrated circuit (ASIC), a soft processor (e.g., a microprocessor core implemented in a field programmable gate array (FPGA) using reconfigurable logic), programmable logic, or other suitable logic circuitry. As will be readily apparent to one of ordinary skill in the art, the disclosed technology can be implemented in various computing platforms, including, but not limited to, servers, mainframes, cellphones, smartphones, PDAs, handheld devices, handheld computers, PDAs, touch screen tablet devices, tablet computers, wearable computers, and laptop computers.

In some examples of the disclosed technology, a block-based processor includes control logic for performing memory operations encoded within in an instruction block that are not architecturally visible until the instruction block commits The memory operations can include memory store instructions and memory store conditional instructions. In some examples, memory synchronization is performed using a load linked instruction and a store conditional instruction in conjunction with registers allocated to store values used in verifying the synchronization. In one example of the disclosed technology, an apparatus includes one or more block-based processor cores coupled to a memory where at least one of the cores includes a control unit configured to issue memory operations encoded in an instruction block allocated to a particular core and to commit the core when execution of the instruction block is complete, a memory store queue configured to cache operands for one or more memory operations where a result and side effects (e.g., a memory store) of performing the memory operations are not architecturally visible until the instruction block is committed by the control unit. The apparatus further includes a memory interface configured to store the cached operands in the memory responsive to the instruction block being committed by the control unit. In some examples, a result value is generated by the memory operation that can be used by subsequent instruction blocks to proceed or reattempt the memory operation, depending on the value of the returned result.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The foregoing and other objects, features, and advantages of the disclosed subject matter will become more apparent from the following detailed description, which proceeds with reference to the accompanying figures.

### BRIEF DESCRIPTION OF THE DRAWINGS

FIG. 1 illustrates a block-based processor core, as can be used in some examples of the disclosed technology.

FIG. 2 illustrates a block-based processor core, as can be used in some examples of the disclosed technology.

FIG. 3 illustrates a number of instruction blocks, according to certain examples of disclosed technology.

FIG. 4 illustrates portions of source code and instruction blocks, as can be used in some examples of the disclosed technology.

FIG. 5 illustrates block-based processor headers and instructions, as can be used in some examples of the disclosed technology.

FIG. 6 is a state diagram illustrating a number of states assigned to an instruction block as it is mapped, executed, and retired.

FIG. 7 illustrates a block-based processor configuration, as can be used in certain examples of the disclosed technology.

FIG. 8 is a block diagram outlining an example of data and control flow performed by a block-based processor when executing a load linked instruction.

FIG. 9 is a block diagram outlining an example of data and control flow performed by a block-based processor when executing and committing a store conditional instruction.

FIG. 10 is a flowchart outlining an example method of executing a memory store instruction in an instruction block, as can be performed in certain examples of the disclosed technology.

FIG. 11 is a flowchart outlining an example method of executing a store conditional instruction with a block-based processor, as can be performed in certain examples of the disclosed technology.

FIG. 12 illustrates source and assembly code, as can be used in certain examples of the disclosed technology.

FIG. 13 is a flowchart outlining and example of transforming code into computer-executable code for a block-based processor including synchronized memory operations, as can be performed in certain examples of the disclosed technology.

FIG. 14 is a block diagram illustrating a suitable computing environment for implementing some embodiments of the disclosed technology.

### DETAILED DESCRIPTION

### I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “emit,” “verify,” “execute,” and “initiate” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application or a software application that is accessed or downloaded via a web browser or other software application (such as a remote computing application). Such software can be executed, for example, on a single local computer (e.g., with general-purpose and/or block based processors executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### II. Introduction to the Disclosed Technologies

Superscalar out-of-order microarchitectures employ substantial circuit resources to rename registers, schedule instructions in dataflow order, clean up after miss-speculation, and retire results in-order for precise exceptions. This includes expensive circuits, such as deep, many-ported register files, many-ported content-accessible memories (CAMs) for dataflow instruction scheduling wakeup, and many-wide bus multiplexers and bypass networks, all of which are resource intensive. For example, FPGA-based implementations of multi-read, multi-write RAMs typically require a mix of replication, multi-cycle operation, clock doubling, bank interleaving, live-value tables, and other expensive techniques.

The disclosed technologies can realize performance enhancement through application of techniques including high instruction-level parallelism (ILP), out-of-order (OoO), superscalar execution, while avoiding substantial complexity and overhead in both processor hardware and associated software. In some examples of the disclosed technology, a block-based processor uses an EDGE ISA designed for area- and energy-efficient, high-ILP execution. In some examples, use of EDGE architectures and associated compilers finesses away much of the register renaming, CAMs, and complexity.

In certain examples of the disclosed technology, an EDGE ISA can eliminate the need for one or more complex architectural features, including register renaming, dataflow analysis, misspeculation recovery, and in-order retirement while supporting mainstream programming languages such as C and C++. In certain examples of the disclosed technology, a block-based processor executes a plurality of two or more instructions as an atomic block. Block-based instructions can be used to express semantics of program data flow and/or instruction flow in a more explicit fashion, allowing for improved compiler and processor performance. In certain examples of the disclosed technology, an explicit data graph execution instruction set architecture (EDGE ISA) includes information about program control flow that can be used to improve detection of improper control flow instructions, thereby increasing performance, saving memory resources, and/or and saving energy.

In some examples of the disclosed technology, instructions organized within instruction blocks are fetched, executed, and committed atomically. Instructions inside blocks execute in dataflow order, which reduces or eliminates using register renaming and provides power-efficient OoO execution. A compiler can be used to explicitly encode data dependencies through the ISA, reducing or eliminating burdening processor core control logic from rediscovering dependencies at runtime. Using predicated execution, intra-block branches can be converted to dataflow instructions, and dependencies, other than memory dependencies, can be limited to direct data dependencies. Disclosed target form encoding techniques allow instructions within a block to communicate their operands directly via operand buffers, reducing accesses to a power-hungry, multi-ported physical register files.

Between instruction blocks, instructions can communicate using memory and registers. Thus, by utilizing a hybrid dataflow execution model, EDGE architectures can still support imperative programming languages and sequential memory semantics, but desirably also enjoy the benefits of out-of-order execution with near in-order power efficiency and complexity. The processor further includes instructions that allow for the use of generally cheaper commodity RAM technology, such as DRAM, to performed synchronized and/or transactional memory operations in multi-processor and/or multi-threaded environments without the use of more expensive RAM including synchronization features. As used herein, memory synchronization instructions include processor instructions that provide a processor mechanism for coordinating access (e.g., coordinating write access and/or read access to a memory location) by threads, processes, or processors (in a multi-processor environment) to shared memory. Examples of memory synchronization instructions include, but are not limited to: load linked/store conditional, compare and swap, and test and set instructions. Memory synchronization store instructions typically provide compound test and store functionality in a single atomic instruction. Thus, other threads, processes, and/or processors are prevented by hardware from modifying (and in some cases, reading) a memory location while the atomic memory synchronization instruction is executing. Memory synchronization instructions do not include generic memory load/store instructions without processor mechanisms for coordinating access. For example, generic, unconditional memory instructions such as load word, load byte, store word, and store byte are not memory synchronization instructions, even though in some cases, programmers attempt to create synchronization routines in software, but without processor support. However, it should be noted that execution of both conditional and unconditional memory instruction can be predicated on a predicate operand.

Apparatus, methods, and computer-readable storage media are disclosed for generation and use of block-based branch metadata for block-based processors. In certain examples of the disclosed technology, instruction blocks include an instruction block header and a plurality of instructions. In other words, the executed instructions of the instruction block affect the state, or do not affect the state as a unit.

In some examples of the disclosed technology, a hardware structure stores data indicating an execution order to be adhered to for a number of memory access instructions, including memory load and memory store instructions. A control unit coupled to a processor core control issuance of memory access instructions based at least in part on data stored in the hardware structure. Thus, memory read/write hazards can be avoided, while allowing for instructions in an instruction block to execute as soon as their dependencies are available.

As will be readily understood to one of ordinary skill in the relevant art, a spectrum of implementations of the disclosed technology are possible with various area and performance tradeoffs.

### III. Example Block-Based Processor

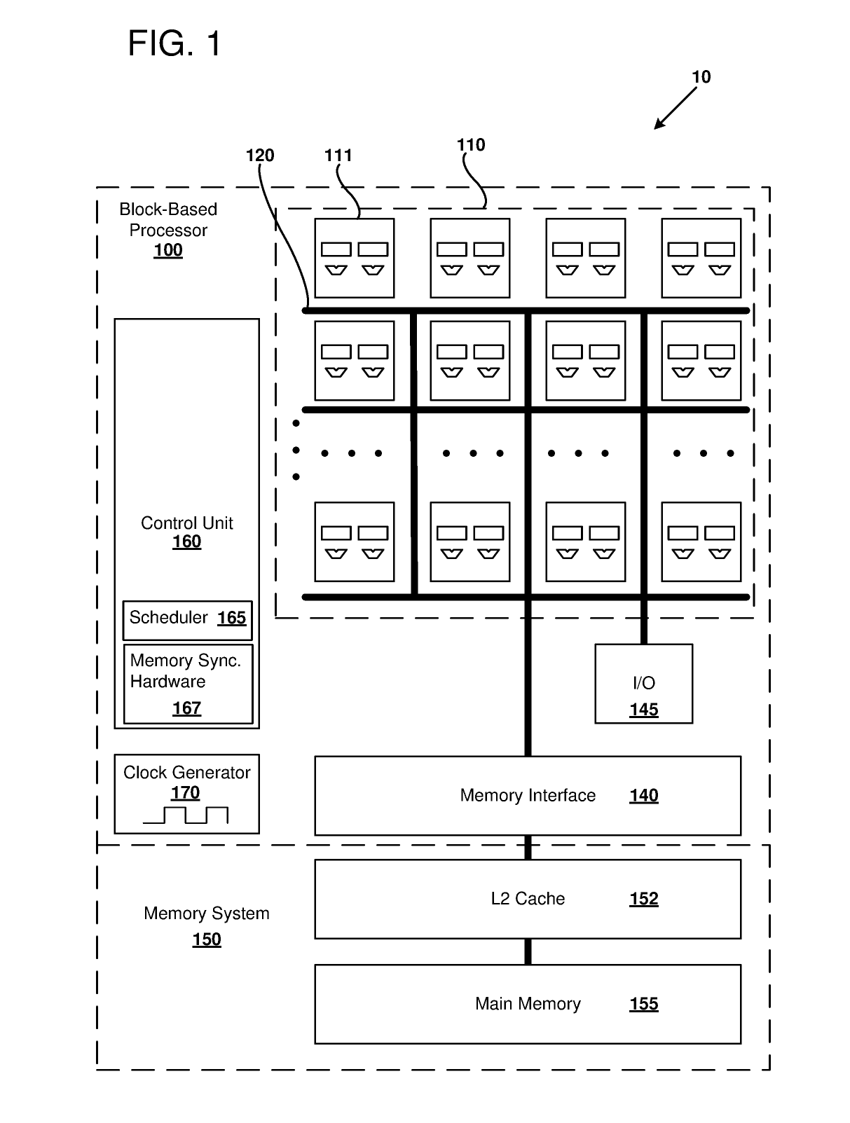

FIG. 1 is a block diagram 10 of a block-based processor 100 as can be implemented in some examples of the disclosed technology. The processor 100 is configured to execute atomic blocks of instructions according to an instruction set architecture (ISA), which describes a number of aspects of processor operation, including a register model, a number of defined operations performed by block-based instructions, a memory model, interrupts, and other architectural features. The block-based processor includes a plurality of processing cores 110, including a processor core 111.

As shown in FIG. 1, the processor cores are connected to each other via core interconnect 120. The core interconnect 120 carries data and control signals between individual ones of the cores 110, a memory interface 140, and an input/output (I/O) interface 145. The core interconnect 120 can transmit and receive signals using electrical, optical, magnetic, or other suitable communication technology and can provide communication connections arranged according to a number of different topologies, depending on a particular desired configuration. For example, the core interconnect 120 can have a crossbar, a bus, a point-to-point bus, or other suitable topology. In some examples, any one of the cores 110 can be connected to any of the other cores, while in other examples, some cores are only connected to a subset of the other cores. For example, each core may only be connected to a nearest 4, 8, or 20 neighboring cores. The core interconnect 120 can be used to transmit input/output data to and from the cores, as well as transmit control signals and other information signals to and from the cores. For example, each of the cores 110 can receive and transmit semaphores that indicate the execution status of instructions currently being executed by each of the respective cores. In some examples, the core interconnect 120 is implemented as wires connecting the cores 110, and memory system, while in other examples, the core interconnect can include circuitry for multiplexing data signals on the interconnect wire(s), switch and/or routing components, including active signal drivers and repeaters, or other suitable circuitry. In some examples of the disclosed technology, signals transmitted within and to/from the processor 100 are not limited to full swing electrical digital signals, but the processor can be configured to include differential signals, pulsed signals, or other suitable signals for transmitting data and control signals.

In the example of FIG. 1, the memory interface 140 of the processor includes interface logic that is used to connect to additional memory, for example, memory located on another integrated circuit besides the processor 100. An external memory system 150 includes an L2 cache 152 and main memory 155. In some examples the L2 cache can be implemented using static RAM (SRAM) and the main memory 155 can be implemented using dynamic RAM (DRAM). In some examples the memory system 150 is included on the same integrated circuit as the other components of the processor 100. In some examples, the memory interface 140 includes a direct memory access (DMA) controller allowing transfer of blocks of data in memory without using register file(s) and/or the processor 100. In some examples, the memory interface manages allocation of virtual memory, expanding the available main memory 155. In some examples, support for bypassing cache structures (e.g., L2 cache 152) or for ensuring cache coherency when performing memory synchronization operations (e.g., handling contention issues or shared memory between plural different threads, processes, or processors) are provided by the memory interface 140 and/or respective cache structures.

The I/O interface 145 includes circuitry for receiving and sending input and output signals to other components, such as hardware interrupts, system control signals, peripheral interfaces, co-processor control and/or data signals (e.g., signals for a graphics processing unit, floating point coprocessor, physics processing unit, digital signal processor, or other co-processing components), clock signals, semaphores, or other suitable I/O signals. The I/O signals may be synchronous or asynchronous. In some examples, all or a portion of the I/O interface is implemented using memory-mapped I/O techniques in conjunction with the memory interface 140.

The block-based processor 100 can also include a control unit 160. The control unit 160 supervises operation of the processor 100. Operations that can be performed by the control unit 160 can include allocation and de-allocation of cores for performing instruction processing, control of input data and output data between any of the cores, register files, the memory interface 140, and/or the I/O interface 145, modification of execution flow, and verifying target location(s) of branch instructions, instruction headers, and other changes in control flow. The control unit 160 can generate and control the processor according to control flow and metadata information representing exit points and control flow probabilities for instruction blocks.

The control unit 160 can also process hardware interrupts, and control reading and writing of special system registers, for example the program counter stored in one or more register file(s). In some examples of the disclosed technology, the control unit 160 is at least partially implemented using one or more of the processing cores 110, while in other examples, the control unit 160 is implemented using a non-block-based processing core (e.g., a general-purpose RISC processing core coupled to memory). In some examples, the control unit 160 is implemented at least in part using one or more of: hardwired finite state machines, programmable microcode, programmable gate arrays, or other suitable control circuits. In alternative examples, control unit functionality can be performed by one or more of the cores 110.

The control unit 160 includes a scheduler 165 that is used to allocate instruction blocks to the processor cores 110. As used herein, scheduler block allocation refers to directing operation of an instruction blocks, including initiating instruction block mapping, fetching, decoding, execution, committing, aborting, idling, and refreshing an instruction block. Further, instruction scheduling refers to scheduling the issuance and execution of instructions within an instruction block. For example based on instruction dependencies and data indicating a relative ordering for memory access instructions, the control unit 160 can determine which instruction(s) in an instruction block are ready to issue and initiate issuance and execution of the instructions. Processor cores 110 are assigned to instruction blocks during instruction block mapping. The recited stages of instruction operation are for illustrative purposes, and in some examples of the disclosed technology, certain operations can be combined, omitted, separated into multiple operations, or additional operations added. The scheduler 165 schedules the flow of instructions including allocation and de-allocation of cores for performing instruction processing, control of input data and output data between any of the cores, register files, the memory interface 140, and/or the I/O interface 145. In some examples, the control unit 160 also includes a memory synchronization hardware structure 167, which can be used to store data load linked address register(s) and link bit(s), which can implemented memory synchronization functions such as load linked and store conditional instructions, as discussed in further detail below.

The block-based processor 100 also includes a clock generator 170, which distributes one or more clock signals to various components within the processor (e.g., the cores 110, interconnect 120, memory interface 140, and I/O interface 145). In some examples of the disclosed technology, all of the components share a common clock, while in other examples different components use a different clock, for example, a clock signal having differing clock frequencies. In some examples, a portion of the clock is gated to allowing power savings when some of the processor components are not in use. In some examples, the clock signals are generated using a phase-locked loop (PLL) to generate a signal of fixed, constant frequency and duty cycle. Circuitry that receives the clock signals can be triggered on a single edge (e.g., a rising edge) while in other examples, at least some of the receiving circuitry is triggered by rising and falling clock edges. In some examples, the clock signal can be transmitted optically or wirelessly.

### IV. Example Block-Based Processor Core

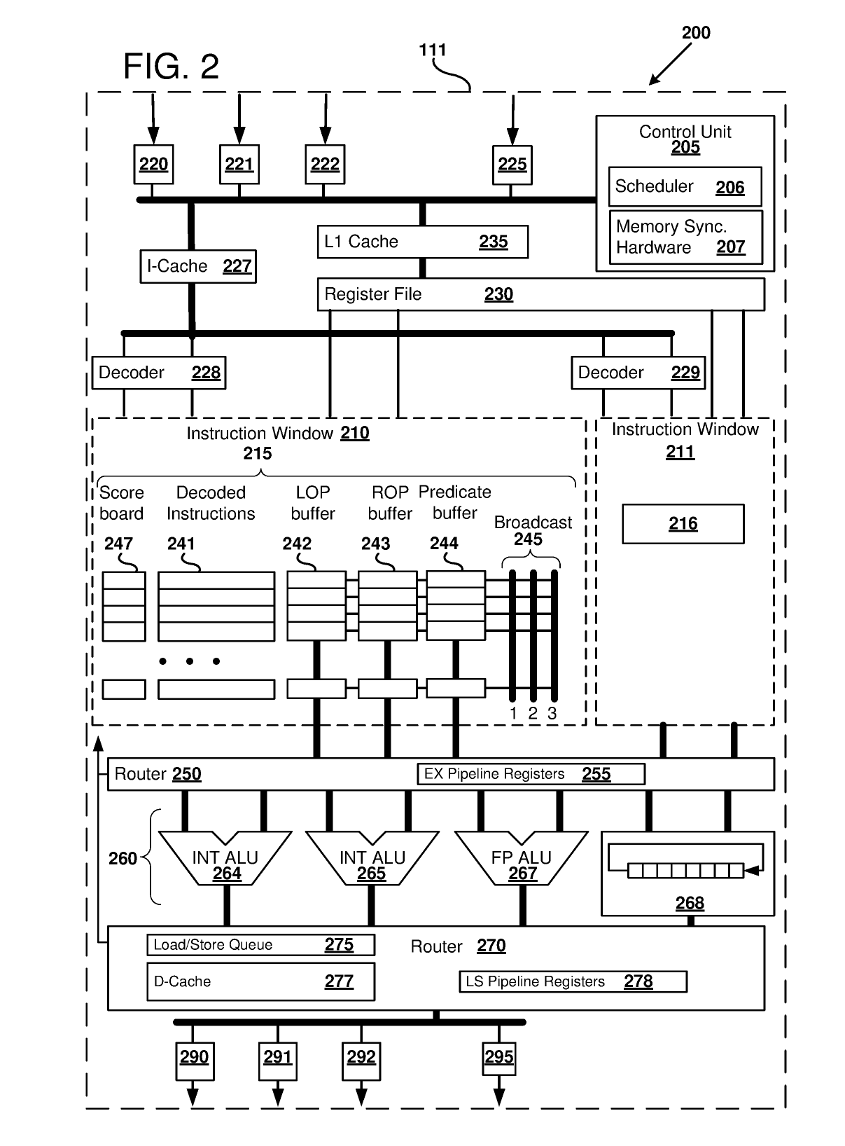

FIG. 2 is a block diagram further detailing an example microarchitecture for the block-based processor 100, and in particular, an instance of one of the block-based processor cores, as can be used in certain examples of the disclosed technology. For ease of explanation, the exemplary block-based processor core is illustrated with five stages: instruction fetch (IF), decode (DC), operand fetch, execute (EX), and memory/data access (LS). However, it will be readily understood by one of ordinary skill in the relevant art that modifications to the illustrated microarchitecture, such as adding/removing stages, adding/removing units that perform operations, and other implementation details can be modified to suit a particular application for a block-based processor.

As shown in FIG. 2, the processor core 111 includes a control unit 205, which generates control signals to regulate core operation and schedules the flow of instructions within the core using an instruction scheduler 206. Operations that can be performed by the control unit 205 and/or instruction scheduler 206 can include generating and using generating and using memory access instruction encodings, allocation and de-allocation of cores for performing instruction processing, control of input data and output data between any of the cores, register files, the memory interface 140, and/or the I/O interface 145.

In some examples, the instruction scheduler 206 is implemented using a general-purpose processor coupled to memory, the memory being configured to store data for scheduling instruction blocks. In some examples, instruction scheduler 206 is implemented using a special purpose processor or using a block-based processor core coupled to the memory. In some examples, the instruction scheduler 206 is implemented as a finite state machine coupled to the memory. In some examples, an operating system executing on a processor (e.g., a general-purpose processor or a block-based processor core) generates priorities, predictions, and other data that can be used at least in part to schedule instruction blocks with the instruction scheduler 206. As will be readily apparent to one of ordinary skill in the relevant art, other circuit structures, implemented in an integrated circuit, programmable logic, or other suitable logic can be used to implement hardware for the instruction scheduler 206.

The control unit 205 further includes memory (e.g., in an SRAM or register) for storing control flow information.

In some examples, the control unit 205 also includes a memory synchronization hardware structure 207, which can be used to store data load linked address register(s) and link bit(s), which can implemented memory synchronization functions such as load linked and store conditional instructions, as discussed in further detail below. For example, the memory synchronization hardware structure 207 can include registers composed of latches, flip-flops, or other storage for storing data and control bits produced when executing and committing memory store operations, including unconditional memory stores, conditional stores, load linked instructions, and other instructions.

The instruction decoders 228 and 229 can specify a relative order for issuing and executing load and store instructions within a block. For example, a numerical load/store identifier (LSID) can be assigned to each memory access instruction, or to only the memory store instructions. A higher-numbered LSID indicates that the instruction should execute after a lower-numbered LSID. In some examples, the processor can determine that two load/store instructions do not conflict (e.g., based on the read/write address for the instruction) and can execute the instructions in a different order, although the resulting state of the machine should not be different than as if the instructions had executed in the designated LSID ordering. In some examples, load/store instructions having mutually exclusive predicate values can use the same LSID value. For example, if a first load/store instruction is predicated on a value p being true, and second load/store instruction is predicated on a value p being false, then each instruction can have the same LSID value.

The control unit 205 can also process hardware interrupts, and control reading and writing of special system registers, for example the program counter stored in one or more register file(s). In other examples of the disclosed technology, the control unit 205 and/or instruction scheduler 206 are implemented using a non-block-based processing core (e.g., a general-purpose RISC processing core coupled to memory). In some examples, the control unit 205 and/or instruction scheduler 206 are implemented at least in part using one or more of: hardwired finite state machines, programmable microcode, programmable gate arrays, or other suitable control circuits.

The exemplary processor core 111 includes two instructions windows 210 and 211, each of which can be configured to execute an instruction block. In some examples of the disclosed technology, an instruction block is an atomic collection of block-based-processor instructions that includes an instruction block header and a plurality of one or more instructions. As will be discussed further below, the instruction block header includes information that can be used to further define semantics of one or more of the plurality of instructions within the instruction block. Depending on the particular ISA and processor hardware used, the instruction block header can also be used during execution of the instructions, and to improve performance of executing an instruction block by, for example, allowing for early fetching of instructions and/or data, improved branch prediction, speculative execution, improved energy efficiency, and improved code compactness. In other examples, different numbers of instructions windows are possible, such as one, four, eight, or other number of instruction windows.

Each of the instruction windows 210 and 211 can receive instructions and data from one or more of input ports 220, 221, and 222 which connect to an interconnect bus and instruction cache 227, which in turn is connected to the instruction decoders 228 and 229. Additional control signals can also be received on an additional input port 225. Each of the instruction decoders 228 and 229 decodes instruction headers and/or instructions for an instruction block and stores the decoded instructions within a memory store 215 and 216 located in each respective instruction window 210 and 211. Further, each of the decoders 228 and 229 can send data to the control unit 205, for example, to configure operation of the processor core 111 according to execution flags specified in an instruction block header or in an instruction. Each of the instruction decoders 228 and 229 are configured to generate identifiers indicating a relative ordering for one or more memory access instructions in an instruction block. These identifiers can be used to determine that all memory access instructions to be executed for the instruction block have executed. For example, the instruction decoders can analyze the instructions (e.g., by constructing a control flow graph or equivalent) to determine predicates associated with memory access instructions in the block. Based on the predicates, it is determined that certain memory access instructions must execute before other memory access or jump instructions in order to allow proper instruction block implementation.

The processor core 111 further includes a register file 230 coupled to an L1 (level one) cache 235. The register file 230 stores data for registers defined in the block-based processor architecture, and can have one or more read ports and one or more write ports. For example, a register file may include two or more write ports for storing data in the register file, as well as having a plurality of read ports for reading data from individual registers within the register file. In some examples, a single instruction window (e.g., instruction window 210) can access only one port of the register file at a time, while in other examples, the instruction window 210 can access one read port and one write port, or can access two or more read ports and/or write ports simultaneously. In some examples, the register file 230 can include 64 registers, each of the registers holding a word of 32 bits of data. (For convenient explanation, this application will refer to 32-bits of data as a word, unless otherwise specified. Suitable processors according to the disclosed technology could operate with 8-, 16-, 64-, 128-, 256-bit, or another number of bits words) In some examples, some of the registers within the register file 230 may be allocated to special purposes. For example, some of the registers can be dedicated as system registers examples of which include registers storing constant values (e.g., an all zero word), program counter(s) (PC), which indicate the current address of a program thread that is being executed, a physical core number, a logical core number, a core assignment topology, core control flags, execution flags, a processor topology, or other suitable dedicated purpose. In some examples, there are multiple program counter registers, one or each program counter, to allow for concurrent execution of multiple execution threads across one or more processor cores and/or processors. In some examples, program counters are implemented as designated memory locations instead of as registers in a register file. In some examples, use of the system registers may be restricted by the operating system or other supervisory computer instructions. In some examples, the register file 230 is implemented as an array of flip-flops, while in other examples, the register file can be implemented using latches, SRAM, or other forms of memory storage. The ISA specification for a given processor, for example processor 100, specifies how registers within the register file 230 are defined and used.

In some examples, the processor 100 includes a global register file that is shared by a plurality of the processor cores. In some examples, individual register files associate with a processor core can be combined to form a larger file, statically or dynamically, depending on the processor ISA and configuration.

As shown in FIG. 2, the memory store 215 of the instruction window 210 includes a number of decoded instructions 241, a left operand (LOP) buffer 242, a right operand (ROP) buffer 243, a predicate buffer 244, three broadcast channels 245, and an instruction scoreboard 247. The terms left operand (LOP) and right operand (ROP) are used for convenience, and these operands can also be referred to as OP1 and OP0, respectively. In some examples of the disclosed technology, each instruction of the instruction block is decomposed into a row of decoded instructions, left and right operands, and scoreboard data, as shown in FIG. 2. The decoded instructions 241 can include partially- or fully-decoded versions of instructions stored as bit-level control signals. The operand buffers 242 and 243 store operands (e.g., register values received from the register file 230, data received from memory, immediate operands coded within an instruction, operands calculated by an earlier-issued instruction, or other operand values) until their respective decoded instructions are ready to execute. Instruction operands and predicates are read from the operand buffers 242 and 243 and predicate buffer 244, respectively, not the register file. The instruction scoreboard 247 can include a buffer for predicates directed to an instruction, including wire-OR logic for combining predicates sent to an instruction by multiple instructions.

The memory store 216 of the second instruction window 211 stores similar instruction information (decoded instructions, operands, and scoreboard) as the memory store 215, but is not shown in FIG. 2 for the sake of simplicity. Instruction blocks can be executed by the second instruction window 211 concurrently or sequentially with respect to the first instruction window, subject to ISA constraints and as directed by the control unit 205.

In some examples of the disclosed technology, front-end pipeline stages IF and DC can run decoupled from the back-end pipelines stages (IS, EX, LS). The control unit can fetch and decode two instructions per clock cycle into each of the instruction windows 210 and 211. The control unit 205 provides instruction window dataflow scheduling logic to monitor the ready state of each decoded instruction's inputs (e.g., each respective instruction's predicate(s) and operand(s) using the scoreboard 247. The control unit 205 further monitors data indicating a relative ordering of memory access instructions (e.g., using load/store identifiers generated by the instruction decoder) and data indicating which instructions have executed (e.g., by tracking each instruction and/or maintaining a count of a number of memory store instructions that have issued). When all of the input operands and predicate(s) for a particular decoded instruction are ready, and any previously-ordered memory access instructions (e.g., previously ordered memory store instructions) have issued and/or executed, the instruction is ready to issue. The control unit 205 then initiates execution of (issues) one or more next instruction(s) (e.g., the lowest numbered ready instruction) each cycle, and control signals based on the decoded instruction and the instruction's input operands are sent to one or more of functional units 260 for execution. The decoded instruction can also encodes a number of ready events. The scheduler in the control unit 205 accepts these and/or events from other sources and updates the ready state of other instructions in the window. Thus execution proceeds, starting with the processor core's 111 ready zero input instructions, instructions that are targeted by the zero input instructions, and so forth.

The decoded instructions 241 need not execute in the same order in which they are arranged within the memory store 215 of the instruction window 210. Rather, the instruction scoreboard 247 is used to track dependencies of the decoded instructions and, when the dependencies have been met, the associated individual decoded instruction is scheduled for execution. For example, a reference to a respective instruction can be pushed onto a ready queue when the dependencies have been met for the respective instruction, and ready instructions can be scheduled in a first-in first-out (FIFO) order from the ready queue. For instructions associated with generated load store identifiers (LSIDs), the execution order will also follow the priorities enumerated in the generated instruction LSIDs, or by executed in an order that appears as if the instructions were executed in the specified order.

Information stored in the scoreboard 247 can include, but is not limited to, the associated instruction's execution predicate(s) (such as whether the instruction is waiting for a predicate bit to be calculated and whether the instruction executes if the predicate bit is true or false), availability of operands to the instruction, or other prerequisites required before issuing and executing the associated individual instruction. The number of instructions that are stored in each instruction window generally corresponds to the number of instructions within an instruction block. In some examples, operands and/or predicates are received on one or more broadcast channels that allow sending the same operand or predicate to a larger number of instructions. In some examples, the number of instructions within an instruction block can be 32, 64, 128, 1,024, or another number of instructions. In some examples of the disclosed technology, an instruction block is allocated across multiple instruction windows within a processor core. Out-of-order operation and memory access can be controlled according to data specifying one or more modes of operation.

In some examples, restrictions are imposed on the processor (e.g., according to an architectural definition, or by a programmable configuration of the processor) to disable execution of instructions out of the sequential order in which the instructions are arranged in an instruction block. In some examples, the lowest-numbered instruction available is configured to be the next instruction to execute. In some examples, control logic traverses the instructions in the instruction block and executes the next instruction that is ready to execute. In some examples, only one instruction can issue and/or execute at a time. In some examples, the instructions within an instruction block issue and execute in a deterministic order (e.g., the sequential order in which the instructions are arranged in the block). In some examples, the restrictions on instruction ordering can be configured when using a software debugger to by a user debugging a program executing on a block-based processor.

Instructions can be allocated and scheduled using the control unit 205 located within the processor core 111. The control unit 205 orchestrates fetching of instructions from memory, decoding of the instructions, execution of instructions once they have been loaded into a respective instruction window, data flow into/out of the processor core 111, and control signals input and output by the processor core. For example, the control unit 205 can include the ready queue, as described above, for use in scheduling instructions. The instructions stored in the memory store 215 and 216 located in each respective instruction window 210 and 211 can be executed atomically. Thus, updates to the visible architectural state (such as the register file 230 and the memory) affected by the executed instructions can be buffered locally within the core 200 until the instructions are committed. The control unit 205 can determine when instructions are ready to be committed, sequence the commit logic, and issue a commit signal. For example, a commit phase for an instruction block can begin when all register writes are buffered, all writes to memory (including unconditional and conditional stores) are buffered, and a branch target is calculated. The instruction block can be committed when updates to the visible architectural state are complete. For example, an instruction block can be committed when the register writes are written to as the register file, the stores are sent to a load/store unit or memory controller, and the commit signal is generated. The control unit 205 also controls, at least in part, allocation of functional units 260 to each of the respective instructions windows.

Because the instruction block is committed (or aborted) as an atomic transactional unit, it should be noted that results of certain operations are not available to instructions within an instruction block. For example, a store conditional instruction will return a result value indicating whether the associated memory store operation was successful. This value is generated during block commit, and so is available to subsequent instruction blocks, but not the present instruction block that executed the store conditional instruction. This is in contrast to RISC and CISC architectures that provide results visible on an individual, instruction-by-instruction basis. Thus, additional techniques are disclosed for supporting memory synchronization and other memory operations in a block-based processor environment.

As shown in FIG. 2, a first router 250, which has a number of execution pipeline registers 255, is used to send data from either of the instruction windows 210 and 211 to one or more of the functional units 260, which can include but are not limited to, integer ALUs (arithmetic logic units) (e.g., integer ALUs 264 and 265), floating point units (e.g., floating point ALU 267), shift/rotate logic (e.g., barrel shifter 268), or other suitable execution units, which can including graphics functions, physics functions, and other mathematical operations. Data from the functional units 260 can then be routed through a second router 270 to outputs 290, 291, and 292, routed back to an operand buffer (e.g. LOP buffer 242 and/or ROP buffer 243), or fed back to another functional unit, depending on the requirements of the particular instruction being executed. The second router 270 include a load/store queue 275, which can be used to issue memory instructions, a data cache 277, which stores data being input to or output from the core to memory, and load/store pipeline register 278.

The core also includes control outputs 295 which are used to indicate, for example, when execution of all of the instructions for one or more of the instruction windows 210 or 211 has completed. When execution of an instruction block is complete, the instruction block is designated as “committed” and signals from the control outputs 295 can in turn can be used by other cores within the block-based processor 100 and/or by the control unit 160 to initiate scheduling, fetching, and execution of other instruction blocks. Both the first router 250 and the second router 270 can send data back to the instruction (for example, as operands for other instructions within an instruction block). In some examples, data indicating relative ordering and execution status is used to determine whether the instruction block can be committed.

As will be readily understood to one of ordinary skill in the relevant art, the components within an individual core 200 are not limited to those shown in FIG. 2, but can be varied according to the requirements of a particular application. For example, a core may have fewer or more instruction windows, a single instruction decoder might be shared by two or more instruction windows, and the number of and type of functional units used can be varied, depending on the particular targeted application for the block-based processor. Other considerations that apply in selecting and allocating resources with an instruction core include performance requirements, energy usage requirements, integrated circuit die, process technology, and/or cost.

It will be readily apparent to one of ordinary skill in the relevant art that trade-offs can be made in processor performance by the design and allocation of resources within the instruction window (e.g., instruction window 210) and control unit 205 of the processor cores 110. The area, clock period, capabilities, and limitations substantially determine the realized performance of the individual cores 110 and the throughput of the block-based processor 100.

The instruction scheduler 206 can have diverse functionality. In certain higher performance examples, the instruction scheduler is highly concurrent. For example, each cycle, the decoder(s) write instructions' decoded ready state and decoded instructions into one or more instruction windows, selects the next instruction to issue, and, in response the back end sends ready events—either target-ready events targeting a specific instruction's input slot (predicate, left operand, right operand, etc.), or broadcast-ready events targeting all instructions. The per-instruction ready state bits, together with the decoded ready state can be used to determine that the instruction is ready to issue.

In some cases, the scheduler 206 accepts events for target instructions that have not yet been decoded and must also inhibit reissue of issued ready instructions. In some examples, instructions can be non-predicated, or predicated (based on a true or false condition). A predicated instruction does not become ready until it is targeted by another instruction's predicate result, and that result matches the predicate condition. If the associated predicate does not match, the instruction never issues. In some examples, predicated instructions may be issued and executed speculatively. In some examples, a processor may subsequently check that speculatively issued and executed instructions were correctly speculated. In some examples a misspeculated issued instruction and the specific transitive closure of instructions in the block that consume its outputs may be re-executed, or misspeculated side effects annulled. In some examples, discovery of a misspeculated instruction leads to the complete roll back and re-execution of an entire block of instructions.

Upon branching to a new instruction block, the respective instruction window(s) ready state is cleared (a block reset). However when an instruction block branches back to itself (a block refresh), only active ready state is cleared. The decoded ready state for the instruction block can thus be preserved so that it is not necessary to re-fetch and decode the block's instructions. Hence, block refresh can be used to save time and energy in loops.

### V. Example Stream of Instruction Blocks

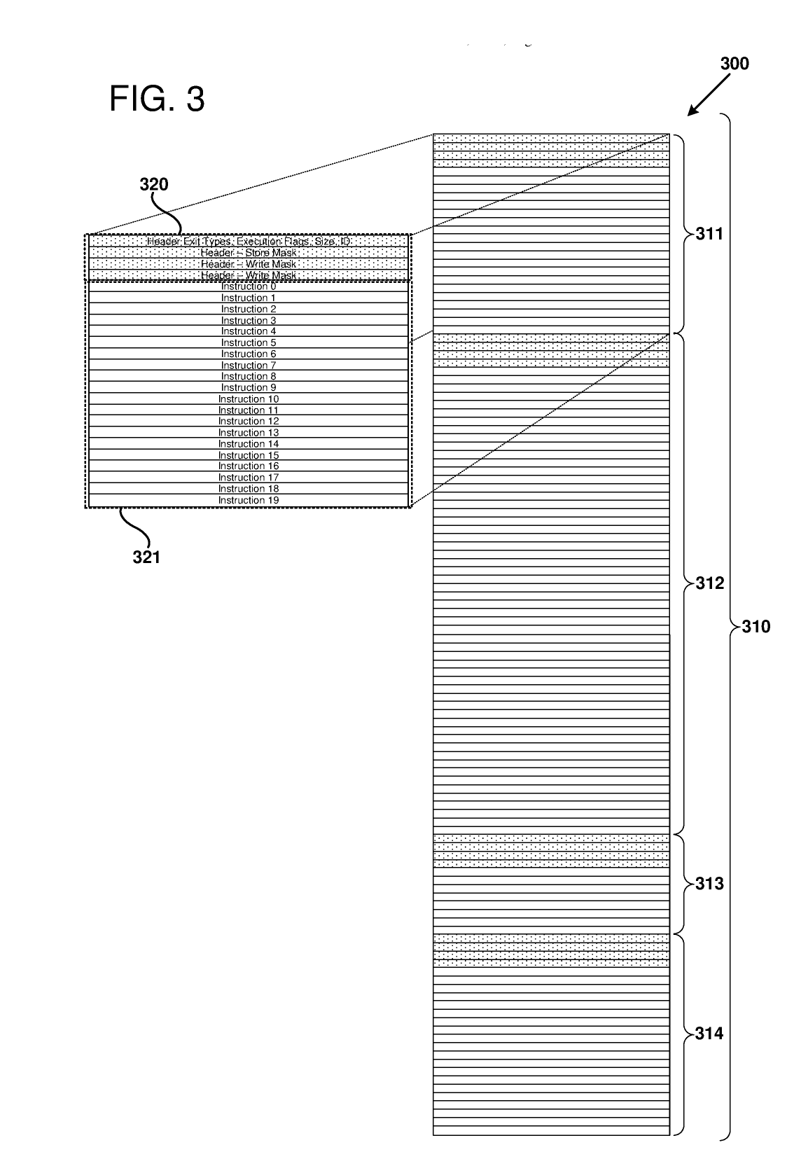

Turning now to the diagram 300 of FIG. 3, a portion 310 of a stream of block-based instructions, including a number of variable length instruction blocks 311-314 is illustrated. The stream of instructions can be used to implement user application, system services, or any other suitable use. The stream of instructions can be stored in memory, received from another process in memory, received over a network connection, or stored or received in any other suitable manner In the example shown in FIG. 3, each instruction block begins with an instruction header, which is followed by a varying number of instructions. For example, the instruction block 311 includes a header 320 and twenty instructions 321. The particular instruction header 320 illustrated includes a number of data fields that control, in part, execution of the instructions within the instruction block, and also allow for improved performance enhancement techniques including, for example branch prediction, speculative execution, lazy evaluation, and/or other techniques. The instruction header 320 also includes an indication of the instruction block size. The instruction block size can be in larger chunks of instructions than one, for example, the number of 4-instruction chunks contained within the instruction block. In other words, the size of the block is shifted 4 bits in order to compress header space allocated to specifying instruction block size. Thus, a size value of 0 indicates a minimally-sized instruction block which is a block header followed by four instructions. In some examples, the instruction block size is expressed as a number of bytes, as a number of words, as a number of n-word chunks, as an address, as an address offset, or using other suitable expressions for describing the size of instruction blocks. In some examples, the instruction block size is indicated by a terminating bit pattern in the instruction block header and/or footer.

The instruction block header 320 can also include one or more execution flags that indicate one or more modes of operation for executing the instruction block. For example, the modes of operation can include core fusion operation, vector mode operation, memory dependence prediction, and/or in-order or deterministic instruction execution. Further, the execution flags can include a block synchronization flag that inhibits speculative execution of the instruction block.

In some examples of the disclosed technology, the instruction header 320 includes one or more identification bits that indicate that the encoded data is an instruction header. For example, in some block-based processor ISAs, a single ID bit in the least significant bit space is always set to the binary value 1 to indicate the beginning of a valid instruction block. In other examples, different bit encodings can be used for the identification bit(s). In some examples, the instruction header 320 includes information indicating a particular version of the ISA for which the associated instruction block is encoded.

The block instruction header can also include a number of block exit types for use in, for example, branch prediction, control flow determination, and/or branch processing. The exit type can indicate what the type of branch instructions are, for example: sequential branch instructions, which point to the next contiguous instruction block in memory; offset instructions, which are branches to another instruction block at a memory address calculated relative to an offset; subroutine calls, or subroutine returns. By encoding the branch exit types in the instruction header, the branch predictor can begin operation, at least partially, before branch instructions within the same instruction block have been fetched and/or decoded.

The illustrated instruction block header 320 also includes a store mask that indicates which of the load-store queue identifiers encoded in the block instructions are assigned to store operations. The instruction block header can also include a write mask, which identifies which global register(s) the associated instruction block will write. In some examples, the store mask is stored in a store vector register by, for example, an instruction decoder (e.g., decoder 228 or 229). In other examples, the instruction block header 320 does not include the store mask, but the store mask is generated dynamically by the instruction decoder by analyzing instruction dependencies when the instruction block is decoded. For example, the decoder can generate load store identifiers for instruction block instructions to determine a store mask and store the store mask data in a store vector register. Similarly, in other examples, the write mask is not encoded in the instruction block header, but is generated dynamically (e.g., by analyzing registers referenced by instructions in the instruction block) by an instruction decoder) and stored in a write mask register. The write mask can be used to determine when execution of an instruction block has completed and thus to initiate commitment of the instruction block. The associated register file must receive a write to each entry before the instruction block can complete. In some examples a block-based processor architecture can include not only scalar instructions, but also single-instruction multiple-data (SIMD) instructions, that allow for operations with a larger number of data operands within a single instruction.

Examples of suitable block-based instructions that can be used for the instructions 321 can include instructions for executing integer and floating-point arithmetic, logical operations, type conversions, register reads and writes, memory loads and stores, execution of branches and jumps, and other suitable processor instructions. In some examples, the instructions include instructions for configuring the processor to operate according to one or more of operations by, for example, speculative execution based on control flow and data regarding memory access instructions stored in a hardware structure, such as a store instruction data store 207. In some examples, the store instruction data store 207 is not architecturally visible. In some examples, access to the store instruction data store 207 is configured to be limited to processor operation in a supervisory mode or other protected mode of the processor.

### VI. Example Block Instruction Target Encoding

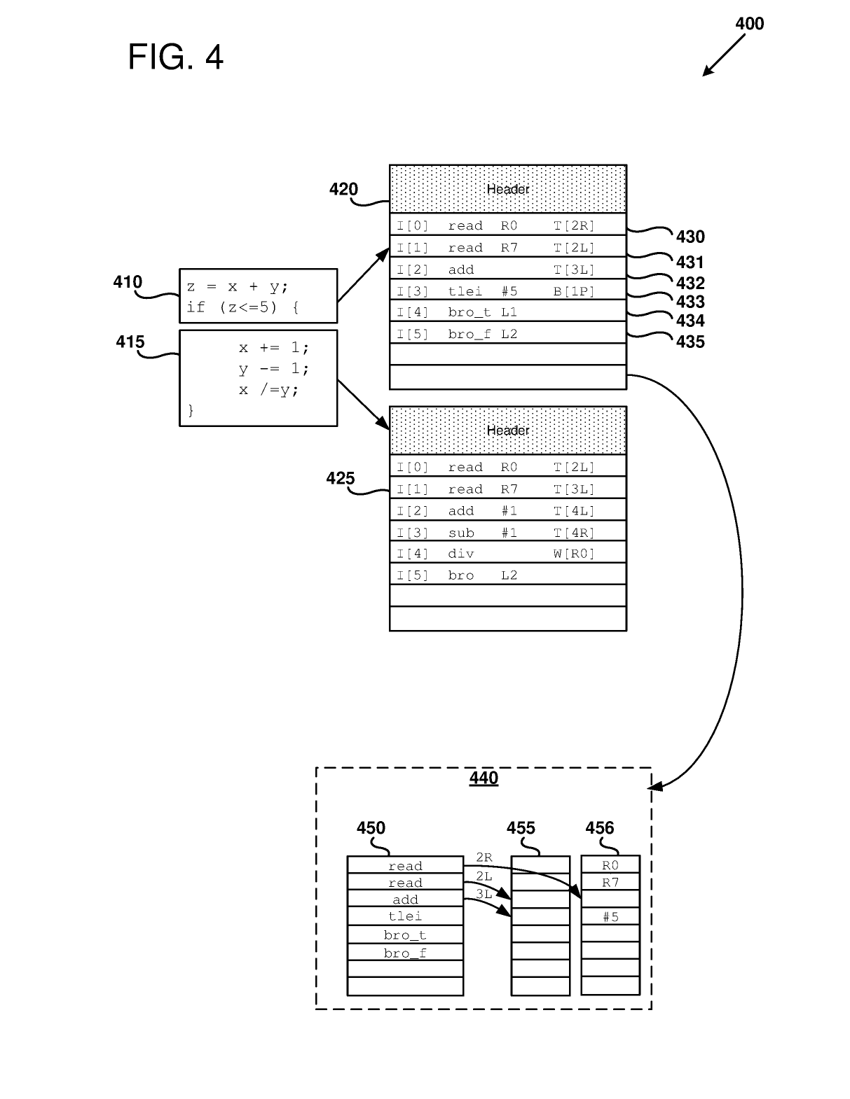

FIG. 4 is a diagram 400 depicting an example of two portions 410 and 415 of C language source code and their respective instruction blocks 420 and 425, illustrating how block-based instructions can explicitly encode their targets. In this example, the first two READ instructions 430 and 431 target the right (T[2R]) and left (T[2L]) operands, respectively, of the ADD instruction 432 (2R indicates targeting the right operand of instruction number 2; 2L indicates the left operand of instruction number 2). In the illustrated ISA, the read instruction is the only instruction that reads from the global register file (e.g., register file 230); however any instruction can target, the global register file. When the ADD instruction 432 receives the result of both register reads it will become ready and execute. It is noted that the present disclosure sometimes refers to the right operand as OP0 and the left operand as OP1.

When the TLEI (test-less-than-equal-immediate) instruction 433 receives its single input operand from the ADD, it will become ready to issue and execute. The test then produces a predicate operand that is broadcast on channel one (B[1P]) to all instructions listening on the broadcast channel for the predicate, which in this example are the two predicated branch instructions (BRO_T 434 and BRO_F 435). The branch instruction that receives a matching predicate will fire (execute), but the other instruction, encoded with the complementary predicated, will not fire/execute.

A dependence graph 440 for the instruction block 420 is also illustrated, as an array 450 of instruction nodes and their corresponding operand targets 455 and 456. This illustrates the correspondence between the block instructions 420, the corresponding instruction window entries, and the underlying dataflow graph represented by the instructions. Here decoded instructions READ 430 and READ 431 are ready to issue, as they have no input dependencies. As they issue and execute, the values read from registers R0 and R7 are written into the right and left operand buffers of ADD 432, marking the left and right operands of ADD 432 “ready.” As a result, the ADD 432 instruction becomes ready, issues to an ALU, executes, and the sum is written to the left operand of the TLEI instruction 433.

### VII. Example Block-Based Instruction Formats

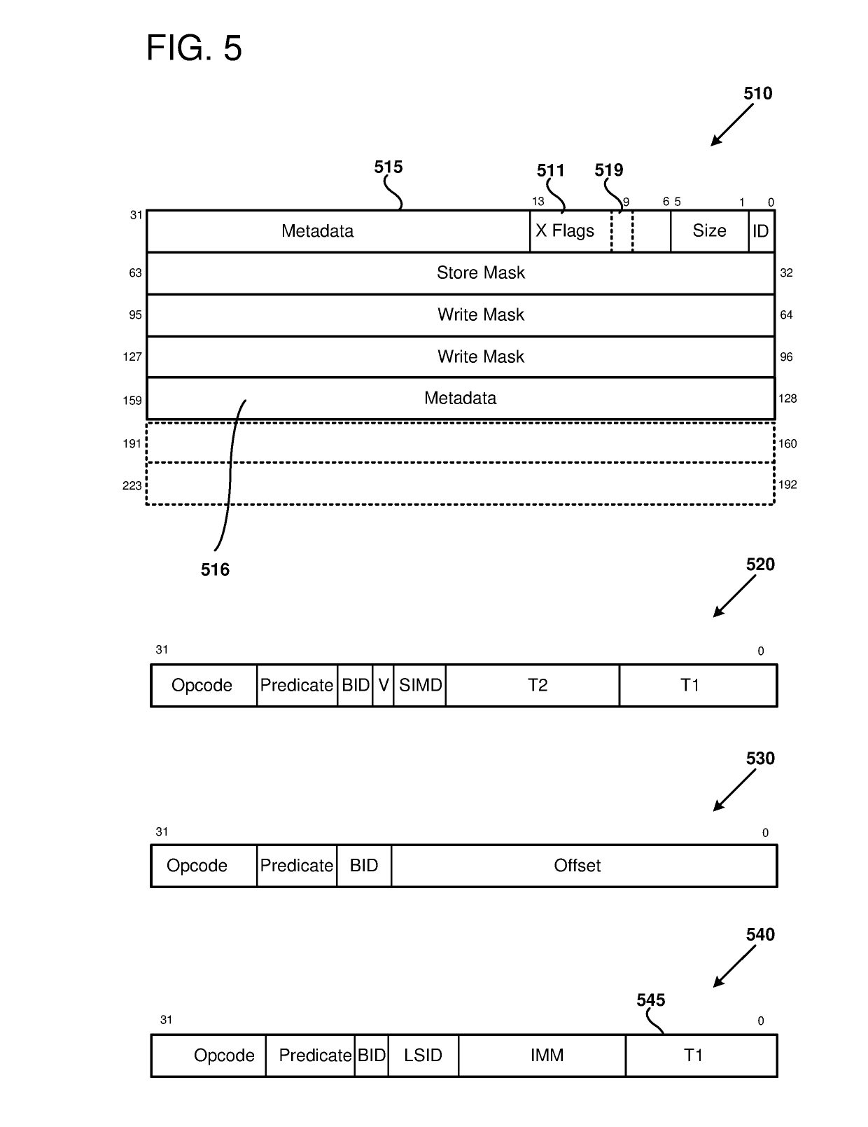

FIG. 5 is a diagram illustrating generalized examples of instruction formats for an instruction header 510, a generic instruction 520, a branch instruction 530, and a memory access instruction 540 (e.g., a memory load or store instruction). The instruction formats can be used for instruction blocks executed according to a number of execution flags specified in an instruction header that specify a mode of operation. Each of the instruction headers or instructions is labeled according to the number of bits. For example the instruction header 510 includes four 32-bit words and is labeled from its least significant bit (lsb) (bit 0) up to its most significant bit (msb) (bit 127). As shown, the instruction header includes a write mask field, a number of exit type fields, a number of execution flag fields, an instruction block size field, and an instruction header ID bit (the least significant bit of the instruction header). In some examples, the instruction header 510 includes additional metadata 515 and/or 516, which can be used to control additional aspects of instruction block execution and performance.

The execution flag fields depicted in FIG. 5 occupy bits 6 through 13 of the instruction block header 510 and indicate one or more modes of operation for executing the instruction block. For example, the modes of operation can include core fusion operation, vector mode operation, branch predictor inhibition, memory dependence predictor inhibition, block synchronization, break after block, break before block, block fall through, and/or in-order or deterministic instruction execution. The block synchronization flag occupies bit 9 of the instruction block and inhibits speculative execution of the instruction block when set to logic Inhibiting speculative execution is highly desirable for example, when shared memory operations such as store conditional instructions or other share memory operations are performed by an instruction block to prevent memory hazards in violation of the ISA specification.

The exit type fields include data that can be used to indicate the types of control flow instructions encoded within the instruction block. For example, the exit type fields can indicate that the instruction block includes one or more of the following: sequential branch instructions, offset branch instructions, indirect branch instructions, call instructions, and/or return instructions. In some examples, the branch instructions can be any control flow instructions for transferring control flow between instruction blocks, including relative and/or absolute addresses, and using a conditional or unconditional predicate. The exit type fields can be used for branch prediction and speculative execution in addition to determining implicit control flow instructions.

The illustrated generic block instruction 520 is stored as one 32-bit word and includes an opcode field, a predicate field, a broadcast ID field (BID), a vector operation field (V), a single instruction multiple data (SIMD) field, a first target field (T1), and a second target field (T2). For instructions with more consumers than target fields, a compiler can build a fanout tree using move instructions, or it can assign high-fanout instructions to broadcasts. Broadcasts support sending an operand over a lightweight network to any number of consumer instructions in a core.

While the generic instruction format outlined by the generic instruction 520 can represent some or all instructions processed by a block-based processor, it will be readily understood by one of skill in the art that, even for a particular example of an ISA, one or more of the instruction fields may deviate from the generic format for particular instructions. The opcode field specifies the operation(s) performed by the instruction 520, such as memory read/write, register load/store, add, subtract, multiply, divide, shift, rotate, system operations, or other suitable instructions. The predicate field specifies the condition under which the instruction will execute. For example, the predicate field can specify the value “true,” and the instruction will only execute if a corresponding condition flag matches the specified predicate value. In some examples, the predicate field specifies, at least in part, which is used to compare the predicate, while in other examples, the execution is predicated on a flag set by a previous instruction (e.g., the preceding instruction in the instruction block). In some examples, the predicate field can specify that the instruction will always, or never, be executed. Thus, use of the predicate field can allow for denser object code, improved energy efficiency, and improved processor performance, by reducing the number of branch instructions.

The target fields T1 and T2 specify the instructions to which the results of the block-based instruction are sent. For example, an ADD instruction at instruction slot 5 can specify that its computed result will be sent to instructions at slots 3 and 10, including specification of the operand slot (e.g., left operation, right operand, or predicate operand). Depending on the particular instruction and ISA, one or both of the illustrated target fields can be replaced by other information, for example, the first target field T1 can be replaced by an immediate operand, an additional opcode, specify two targets, etc.

The branch instruction 530 includes an opcode field, a predicate field, a broadcast ID field (BID), and an offset field. The opcode and predicate fields are similar in format and function as described regarding the generic instruction. The offset can be expressed in units of groups of four instructions, thus extending the memory address range over which a branch can be executed. The predicate shown with the generic instruction 520 and the branch instruction 530 can be used to avoid additional branching within an instruction block. For example, execution of a particular instruction can be predicated on the result of a previous instruction (e.g., a comparison of two operands). If the predicate is false, the instruction will not commit values calculated by the particular instruction. If the predicate value does not match the required predicate, the instruction does not issue. For example, a BRO_F (predicated false) instruction will issue if it is sent a false predicate value.

It should be readily understood that, as used herein, the term “branch instruction” is not limited to changing program execution to a relative memory location, but also includes jumps to an absolute or symbolic memory location, subroutine calls and returns, and other instructions that can modify the execution flow. In some examples, the execution flow is modified by changing the value of a system register (e.g., a program counter PC or instruction pointer), while in other examples, the execution flow can be changed by modifying a value stored at a designated location in memory. In some examples, a jump register branch instruction is used to jump to a memory location stored in a register. In some examples, subroutine calls and returns are implemented using jump and link and jump register instructions, respectively.

The memory access instruction 540 format includes an opcode field, a predicate field, a broadcast ID field (BID), an immediate field (IMM), and a target field (T1). The opcode, broadcast, predicate fields are similar in format and function as described regarding the generic instruction. For example, execution of a particular instruction can be predicated on the result of a previous instruction (e.g., a comparison of two operands). If the predicate is false, the instruction will not commit values calculated by the particular instruction. If the predicate value does not match the required predicate, the instruction does not issue. The immediate field can be used as an offset for the operand sent to the load or store instruction (e.g., to shift an address by the number of bits specified in the IMM field). The operand plus (shifted) immediate offset is used as a memory address for the load/store instruction (e.g., an address to read data from, or store data to, in memory). For some instructions, such as a store conditional instruction, the target field T1 545 is used to specify where a status indicator generated by executing will be stored. For example, the target field T1 545 can specify a register to store a status indicator value that indicates whether the store conditional instruction executed successfully or not (e.g., based on the load link address and link values). A subsequent instruction block can check the status indicator value and take appropriate action (e.g., by flushing an instruction block, causing the instruction block to re-execute, raising an exception, etc.).

### VIII. Example Processor State Diagram

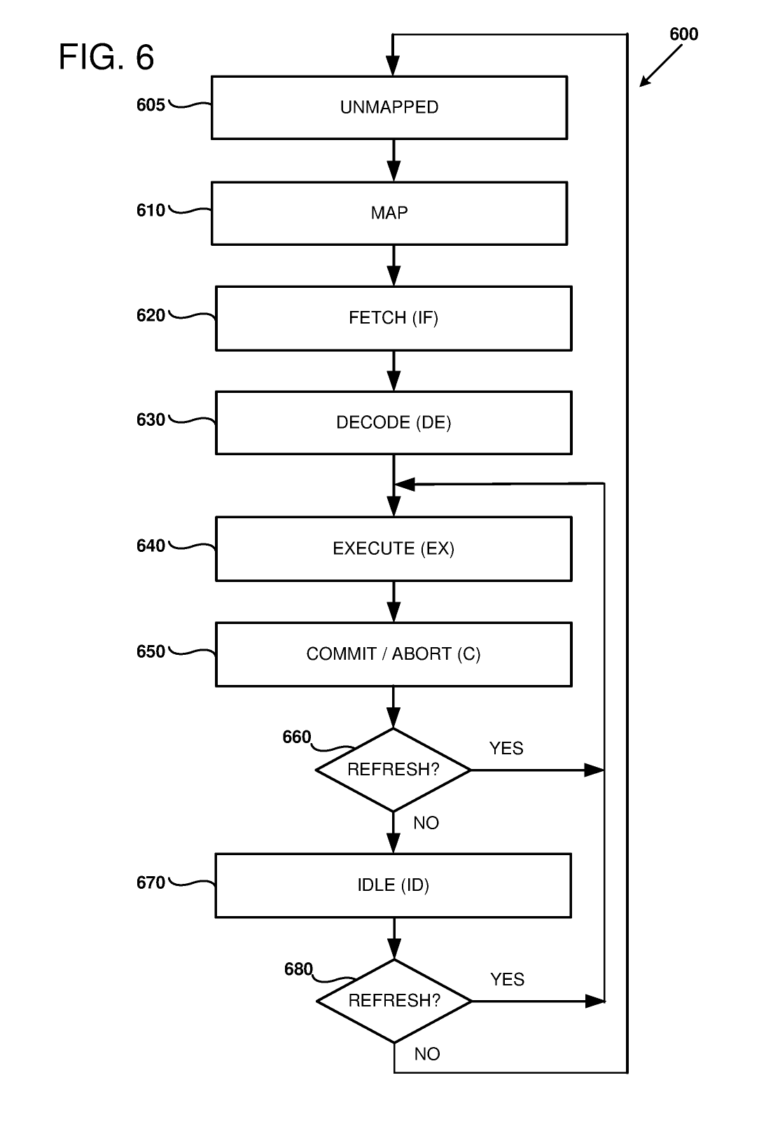

FIG. 6 is a state diagram 600 illustrating number of states assigned to an instruction block as it is mapped, executed, and retired. For example, one or more of the states can be assigned during execution of an instruction according to one or more execution flags. It should be readily understood that the states shown in FIG. 6 are for one example of the disclosed technology, but that in other examples an instruction block may have additional or fewer states, as well as having different states than those depicted in the state diagram 600. At state 605, an instruction block is unmapped. The instruction block may be resident in memory coupled to a block-based processor, stored on a computer-readable storage device such as a hard drive or a flash drive, and can be local to the processor or located at a remote server and accessible using a computer network. The unmapped instructions may also be at least partially resident in a cache memory coupled to the block-based processor.

At instruction block map state 610, control logic for the block-based processor, such as an instruction scheduler, can be used to monitor processing core resources of the block-based processor and map the instruction block to one or more of the processing cores.

The control unit can map one or more of the instruction block to processor cores and/or instruction windows of particular processor cores. In some examples, the control unit monitors processor cores that have previously executed a particular instruction block and can re-use decoded instructions for the instruction block still resident on the “warmed up” processor core. Once the one or more instruction blocks have been mapped to processor cores, the instruction block can proceed to the fetch state 620.

When the instruction block is in the fetch state 620 (e.g., instruction fetch), the mapped processor core fetches computer-readable block instructions from the block-based processors' memory system and loads them into a memory associated with a particular processor core. For example, fetched instructions for the instruction block can be fetched and stored in an instruction cache within the processor core. The instructions can be communicated to the processor core using core interconnect. Once at least one instruction of the instruction block has been fetched, the instruction block can enter the instruction decode state 630.

During the instruction decode state 630, various bits of the fetched instruction are decoded into signals that can be used by the processor core to control execution of the particular instruction, including generation of identifiers indicating relative ordering of memory access instructions. For example, the decoded instructions can be stored in one of the memory stores 215 or 216 shown above, in FIG. 2. The decoding includes generating dependencies for the decoded instruction, operand information for the decoded instruction, and targets for the decoded instruction. Once at least one instruction of the instruction block has been decoded, the instruction block can proceed to execution state 640.

During the execution state 640, operations associated with the instruction are performed using, for example, functional units 260 as discussed above regarding FIG. 2. As discussed above, the functions performed can include arithmetical functions, logical functions, branch instructions, memory operations, and register operations. Control logic associated with the processor core monitors execution of the instruction block, and once it is determined that the instruction block can either be committed, or the instruction block is to be aborted, the instruction block state is set to commit/abort 650. In some examples, the control logic uses a write mask and/or a store mask for an instruction block to determine whether execution has proceeded sufficiently to commit the instruction block.

At the commit/abort state 650, the processor core control unit determines that operations performed by the instruction block can be completed. For example memory load store operations, register read/writes, branch instructions, and other instructions will definitely be performed according to the control flow of the instruction block. For conditional memory instructions, data will be written to memory, and a status indicator value that indicates success generated during the commit/abort state 650. Alternatively, if the instruction block is to be aborted, for example, because one or more of the dependencies of instructions are not satisfied, or the instruction was speculatively executed on a predicate for the instruction block that was not satisfied, the instruction block is aborted so that it will not affect the state of the sequence of instructions in memory or the register file. Regardless of whether the instruction block has committed or aborted, the instruction block goes to state 660 to determine whether the instruction block should be refreshed. If the instruction block is refreshed, the processor core re-executes the instruction block, typically using new data values, particularly the registers and memory updated by the just-committed execution of the block, and proceeds directly to the execute state 640. Thus, the time and energy spent in mapping, fetching, and decoding the instruction block can be avoided. Alternatively, if the instruction block is not to be refreshed, then the instruction block enters an idle state 670.

In the idle state 670, the processor core executing the instruction block can be idled by, for example, powering down hardware within the processor core, while maintaining at least a portion of the decoded instructions for the instruction block. At some point, the control unit determines 680 whether the idle instruction block on the processor core is to be refreshed or not. If the idle instruction block is to be refreshed, the instruction block can resume execution at execute state 640. Alternatively, if the instruction block is not to be refreshed, then the instruction block is unmapped and the processor core can be flushed and subsequently instruction blocks can be mapped to the flushed processor core.

While the state diagram 600 illustrates the states of an instruction block as executing on a single processor core for ease of explanation, it should be readily understood to one of ordinary skill in the relevant art that in certain examples, multiple processor cores can be used to execute multiple instances of a given instruction block, concurrently.

### IX. Example Block-Based Processor and Memory Configuration

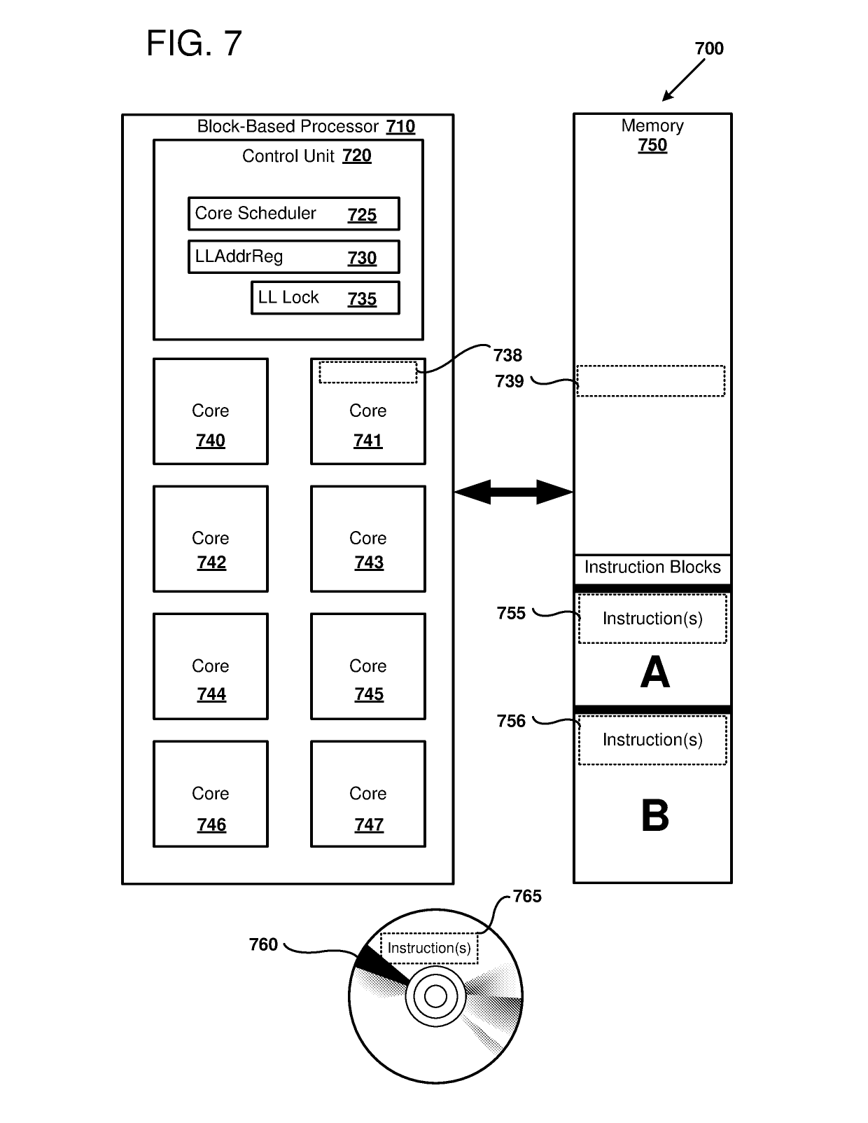

FIG. 7 is a diagram 700 illustrating an apparatus comprising a block-based processor 710, including a control unit 720 configured to execute instruction blocks including instructions for memory operations including memory synchronization and memory locks. The control unit 720 includes a core scheduler. The core scheduler 725 schedules the flow of instructions including allocation and de-allocation of cores for performing instruction processing, control of input data and output data between any of the cores, register files, memory interfaces and/or I/O interfaces. The control unit 720 also includes dedicated registers for performing certain memory operations. For example, a load linked address register 730 and a load linked bit register 735 can be stored to store address and control data used for implementing synchronized memory operations, including conditional stores and load linked operations. In other examples, data stored by the load linked address register 730 and the load linked bit register 735 can be stored in alternative locations 738 and 739 associated with an individual core 741 or in the memory 750. The value stored in the load linked bit register 735 indicates whether the store address is designated to be exclusive to the core executing the load linked instruction. In some examples, a range of addresses can be accessed, and the register stores the size of the data (e.g., in number of bytes or words) in the load linked bit register 735 or another register. In some examples, a zero size indicates that the address is not currently exclusive. In such examples, memory ranges of more than one word can be marked as exclusive. In some examples, each of the cores 740-747 can have only one valid load linked instruction in flight at a time. In such cases, if a load linked instruction to a second memory address occurs after a first active load linked instruction from a first address, then the first address is invalidated.

The block-based processor 710 also includes one or more processer cores 740-747 configured to fetch and execute instruction blocks. Each of the cores includes an instruction decoder that decodes instruction opcodes, extended opcodes, and other fields to determine whether an instruction specifies a variable number and/or type of target operands. The illustrated block-based processor 710 has up to eight cores, but in other examples there could be 64,512,1024, or other numbers of block-based processor cores. The block-based processor 710 is coupled to a memory 750 which includes a number of instruction blocks, including instruction blocks A and B, which include instructions (755 and 756) implementing disclosed memory operations, and to a computer-readable storage media disc 760 that stores instructions 765 for performing disclosed memory operations.

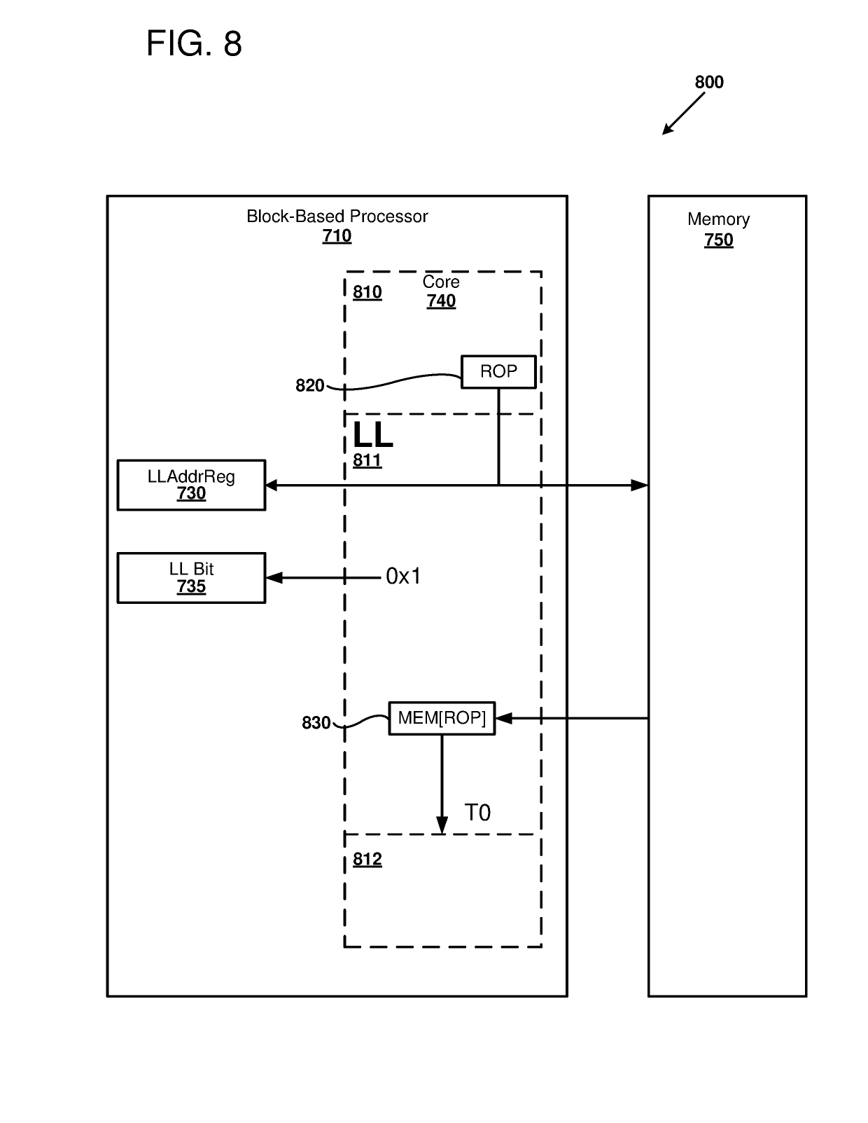

FIG. 8 is a diagram 800 outlining data and control flow between components of the block-based processor 710 and the memory 750 of FIG. 7 when performing operations specified by one example of a load linked instruction. As shown, one of the cores 740 is executing a number of instructions 810, 811 (a load linked instruction) and 812. The instruction 810 sends an address as a right operand value to the load linked instruction 811. When the load linked instruction executes, data stored at the memory address specified by the right operand 820 is read (MEM[ROP] 830) and then sent by the load link instruction to a target instruction (T0). The address ROP is stored in the load linked address register 730, and the value stored in the load link bit register 735 is set to 1. The data read from the memory 750 can be sent to any suitable instruction target including other instructions within the instruction block, or a general register.

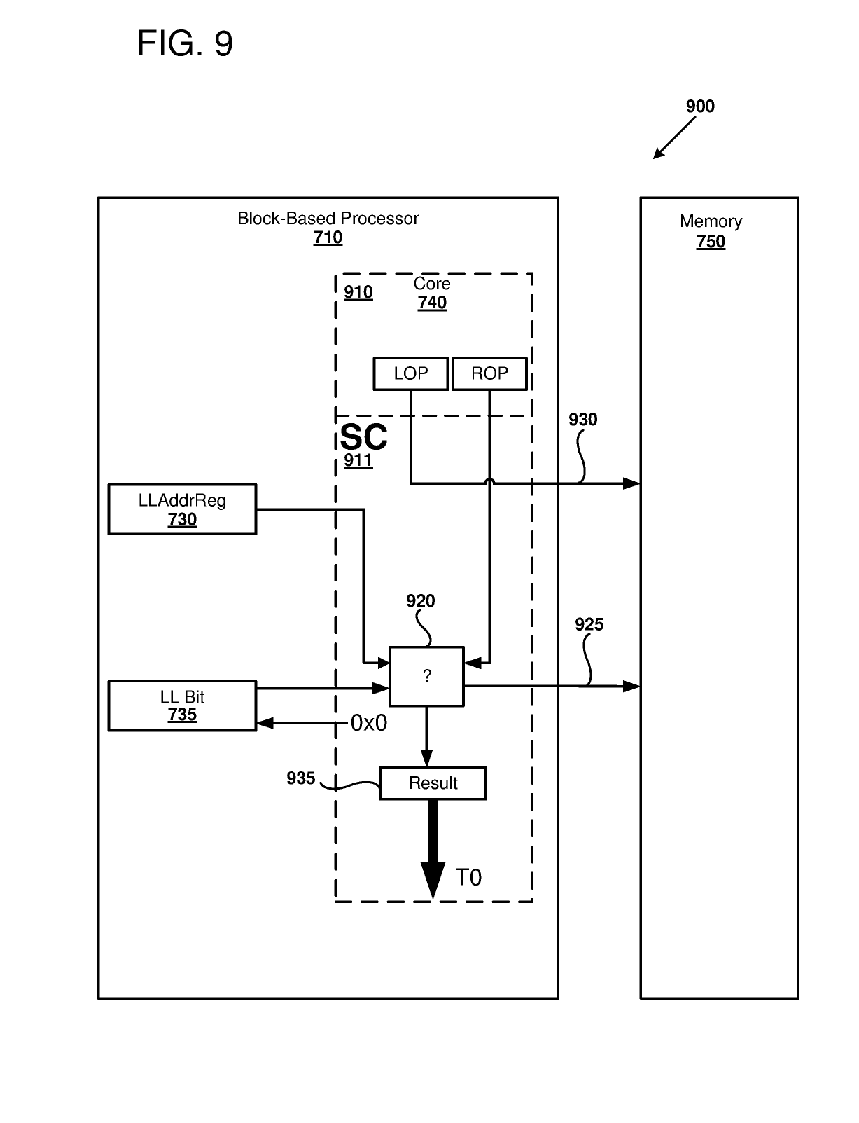

FIG. 9 is a diagram 900 illustrating flow of data and control signals within a block-based processor 710 and the memory 750 when performing one example of a store conditional instruction. A preceding instruction 910 produces left and right target operands (LOP and ROP, respectively) that are sent to a store conditional instruction 911. When executed, the store conditional instruction will compare the right operand ROP to the address stored in the load linked address register 730 using comparison logic 920. When executed, the store conditional instruction will also check the value of the load linked bit from the load linked bit register 735 using the comparison logic 920. If the address stored in the load linked address register 730 is equal to the ROP value and the load linked bit is set to one (1), then a memory control signal 925 is sent to the memory 750 and result data 930 from the instructions left operand LOP slot is written to the memory 750, and, a status indicator value 935 will be zero (0). On the other hand, if either the address comparison fails, or the load linked bit is not set to one (1), then the status indicator value 935 is set to one (1) to indicate failure of the stored conditional instruction. In some examples, a range of addresses can be specified by the preceding load linked instruction (e.g., as a size from a start address for the range or as start and end addresses for a range). In such examples, a store conditional to an address not locked by the executing core will generate a failure as the status indicator value 935. In some examples, the block-based processor 710 further checks for alignment of load linked and store conditional address and indicates a failure upon detecting an unaligned memory access. The status indicator value 935 can be sent to any suitable instruction target (e.g., specified by the target operand T0 encoded for the instruction), including other instructions within the instruction block or a general purpose register. However, because the stored instruction operations are not performed until the block is in the process of committing, a general register will be typically be targeted to store the result so that a next instruction block can evaluate the result and execute instructions for processing accordingly. Regardless of the result of the comparison, the store conditional instruction stores a zero (0) value in the load linked bit register 735.

X. Example Method of Executing Instruction Block with Memory Store Operations

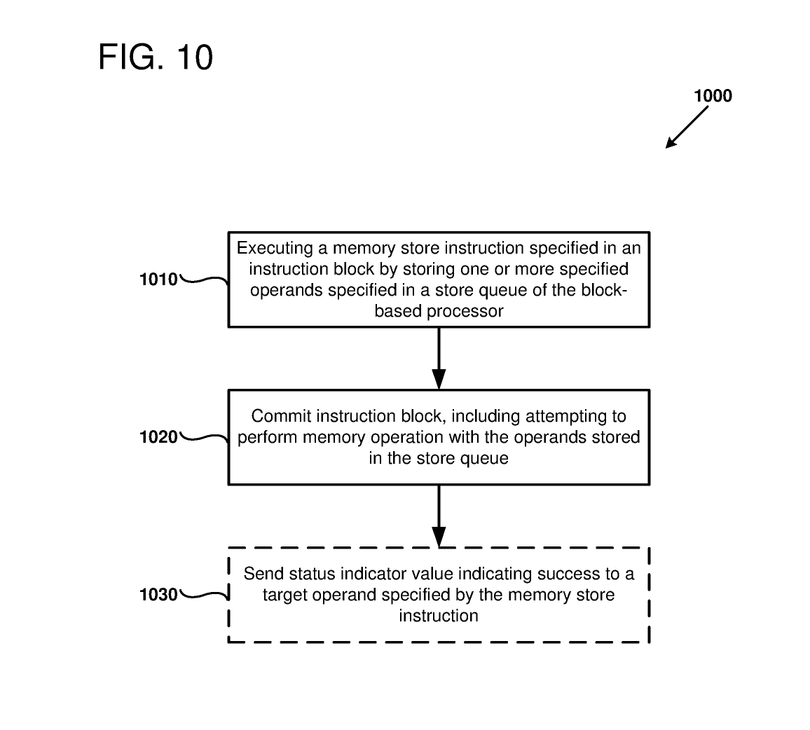

FIG. 10 is a flowchart 1000 outlining an example method of executing an instruction block including memory store instructions, as can be performed in certain examples of the disclosed technology. For example, the block-based processor 100 discussed above regarding FIG. 1 and the block-based processor core 111 discussed above regarding FIG. 2 can be used to perform the illustrated method.

At process block 1010, a memory store instruction specified in an instruction block is executed by storing one or more operands specified by the memory store instruction in a store queue of the block-based processor. For example, address and data values to be used in performing a store operation can be stored in the queue for evaluation during the commit phase of the instruction block. However, the specified memory operation will not be performed until the block commits Thus, the memory operation specified by the memory store instruction is not architecturally visible, because the state of the memory system (including cache and memory) are not changed. After instructions in the instruction block have evaluated, including, for example, evaluation of predicates, evaluation of register writes, and evaluation of memory store instructions, the method proceed to process block 1020.

At process block 1020, the instruction block is committed, by performing any additional operations needed to complete execution of the block. This includes attempting to perform memory operations based on operands that were stored in the store queue at process block 1010. Thus, during the commit phase, the executing processor will attempt to complete performance of memory store instructions, including store conditional instructions. In some examples, the processor executes a number of additional instructions between executing the memory store instruction at process block 1010, and performing instruction block commit at process block 1020. In some examples, if the memory store instruction is a store conditional instruction, then the processor compares an input operand value of the instruction to a value previously stored in a load linked address register. If the address values match, then the memory store operation is performed. In some examples, the processor also evaluates a link value stored in a register and, based on the link value, proceeds to perform the memory store operation. In some examples, prior to executing the memory store instruction at process block 1010, the method includes executing a load linked instruction that causes a processor to read a data value from an address location in a memory unit, store the address location in a load linked address register, and set a link value to indicate that the address location is locked.

If either the input operand value does not match the value stored in the load linked address register, or the link value was not set to the designated value, then the memory operation is not performed, and the instruction is designated as having failed. After the instruction block has committed, the method proceeds to process block 1030.

At process block 1030, a status indicator value generated by the instruction indicating whether the memory store instruction was successful is sent to a target operand. For example, the memory store instruction can specify a general register to store the status indicator value. When a next instruction block executes, a second instruction block can receive the status indicator data via a global register file and take appropriate action. For example, if the store conditional instruction was successful, then execution of the program continues in a normal fashion. However, if the status indicator value indicates a failure of the store conditional, then appropriate action can be taken. For example, the processor can be caused to re-execute the first instruction block containing the memory store instruction, or flush the instruction block. Thus, the processor can be caused to reattempt to perform the memory store instruction until the store is successful. In some examples, the processor is configured to raise a hardware exception, and an operating system or other executable code is invoked to address the failure of the store conditional instruction. In some examples, a value is set in a status register indicating failure of the store conditional instruction when the block commits.

Suitable examples of memory store instructions that can be used with the method outlined in memory synchronization store instructions, including store conditional, test and set, and compare and swap. A processor can be configured such that any of these instructions generate a status indicator value. The status indicator value can be stored to a target operand location (e.g., to a register encoded in the target operand field of the memory synchronization store instruction). In other examples, synchronization instructions are indicated at least in part based on header information for an instruction block. For example, and instruction block header can have a bit that indicates that certain memory operations for the block are synchronized (e.g., a first or last memory operation of the block, all memory operations for the block). In other examples, an instruction block header has one or more bits indicating which instructions within the block are synchronized.

XI. Example Method of Executing Load Linked and Store Conditional Instructions with Block-Based Processor

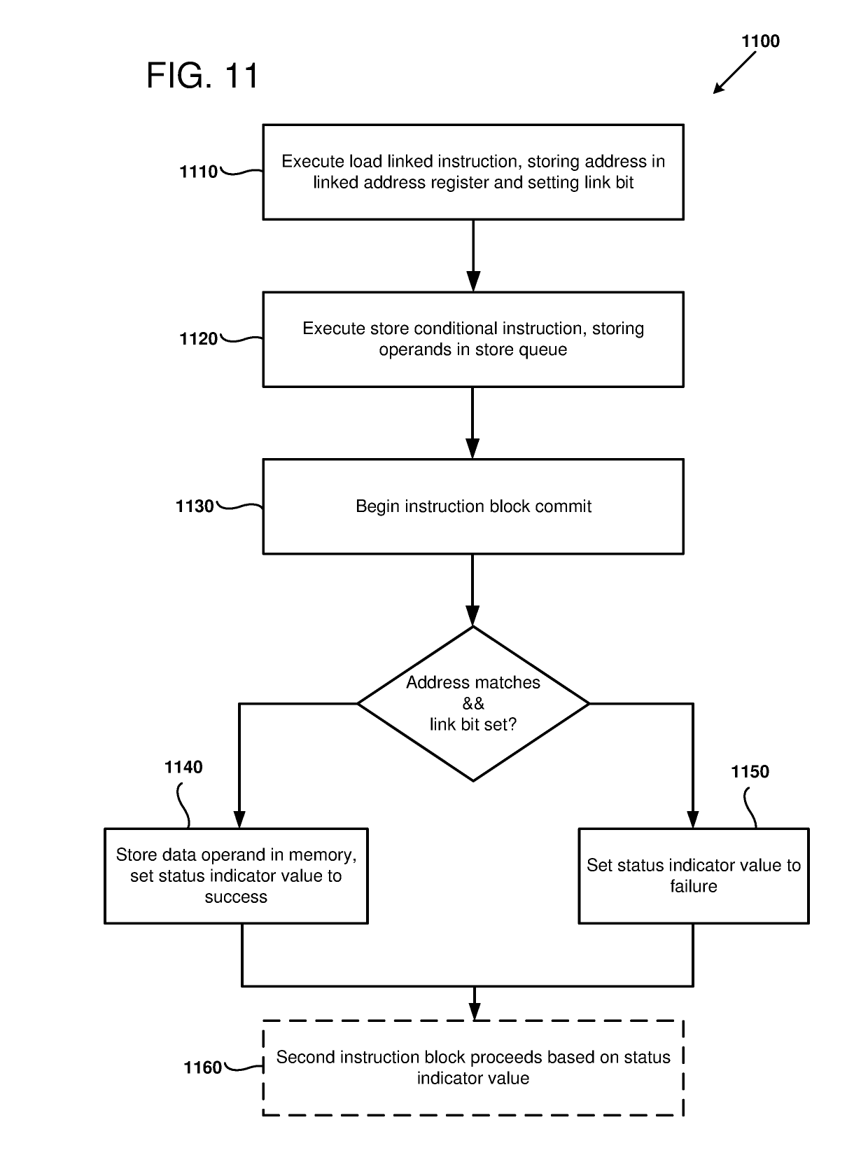

FIG. 11 is a flowchart 1100 outlining an example of executing a load linked instruction and store conditional instruction, as can be performed in certain examples of the disclosed technology. For example, any of the processor cores of the block-based processor described above regarding FIG. 1 can be used to implement the illustrated method.

At process block 1110, a block-based processor executes a load link instruction which stores specified memory address in a linked address register and sets a link bit. In some examples, the linked address register and the link bit are not directly visible to the programmer, other than the manner in which they cause subsequent memory operations (e.g., store conditional instructions) to execute. In other examples, data for the linked address register and/or the link bit can be stored in a memory or register that are architecturally visible. After executing the load linked instruction, the method proceeds to process block 1120.

At process block 1120, a store conditional instruction is executed, which stores one or more operands specified by the store conditional instruction (e.g., the store conditional instruction's left operand) in the store queue. It should be noted that the load linked instruction and the store conditional instruction need not be contained within the same instruction block. The store conditional instruction operands will typically specify a data value and an address (e.g., the store conditional instruction's right operand) to store the data value in memory coupled to a block-based processor core. It can be especially useful to use the disclosed synchronization methods in multi-processor and multi-threaded applications in order to control access to shared memory locations. After executing the store conditional instruction, the method proceeds to process block 1130.

At process block 1130, the executing processor core begins committing the instruction block. For example, once a suitable number of predicates have been evaluated, and values read by the instruction block have been read, and there is no additional work to be performed by the block, the instruction block can begin commit Committing the steps performed as part of instruction block commitment include performing memory operations waiting in the store queue. Thus, the store operations are not architecturally visible until the instruction block reaches the commit phase. In order to commit a store conditional instruction, the method checks to see whether a destination address specified by the store conditional instruction matches an address stored in the link address register, and whether the link bit is set. If both conditions are true, then the method proceeds to process block 1140. On the other hand, if either condition is false, then the method proceeds to process block 1150.

At process block 1140, the processor stores data specified by the memory instruction in the memory at the specified memory address and sets a status indicator value to indicate success. If, on the other hand, the comparison did not match, then at process block 1150, the status indicator of the instruction is set to failure. In either case, the status indicator value generated by attempting to perform the store conditional instruction is stored in, for example, a general purpose register so that it can be accessed by other instruction blocks, and the method proceeds to process block 1160. In some examples, a target operand of the store conditional instruction specifies a target to send the status indicator to, such as a register in a global register file.

At process block 1160, a second instruction block proceeds based on the status indicator generated by the store conditional instruction. For example, the second instruction block can read the status indicator value from a global register file and perform a branch back to the first instruction block that included the store conditional instruction and attempt to re-execute the store conditional instruction. On the other hand, if the status indicator indicates success, then the method proceeds without attempting to re-execute the store conditional instruction.

### XII. Example Source and Assembly Code for Block-Based Processor

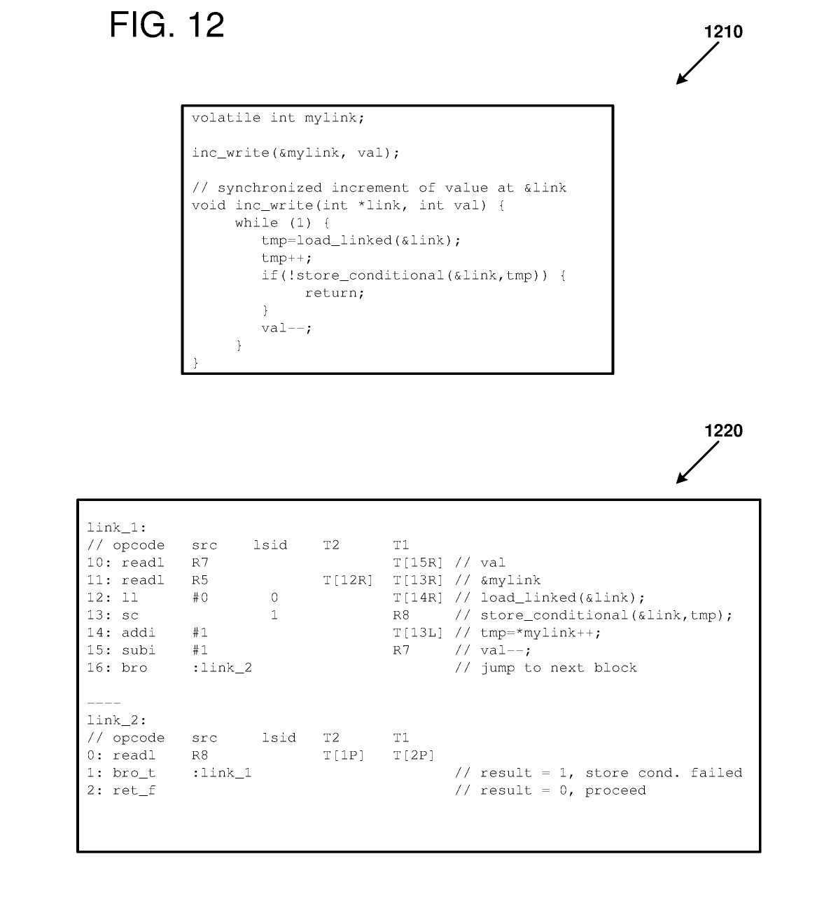

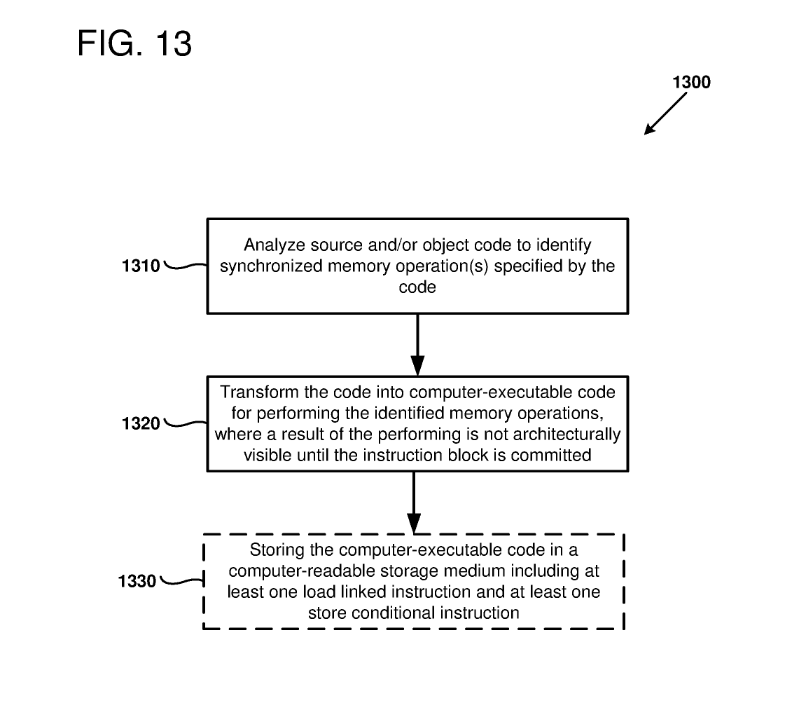

FIG. 12 illustrates an example of source code 1210 and associated assembly code 1220 for performing a synchronized memory operation with a block-based processor, as can be used in certain examples of the disclosed technology. For example, the method of transforming code discussed below regarding FIG. 13 can be used to generate computer-executable instructions that perform the specified memory operations when executed by a block-based processor 100.

The source code 1210 includes a function named inc_write that is used to increment a value stored at a shared memory location at &mylink. The variable mylink is declared with the “volatile” keyword to indicate to the compiler, for example, that the variable may be written to by other threads, processes, or processors besides the local code. The volatile keyword can also indicate that certain compiler optimizations should be disabled or enabled (e.g., by inhibiting speculative execution of the block or re-use of value read from memory).

As shown, the inc_write function will call the load_linked function, which is used to encode a load linked (LL) assembly instruction (instruction ID 12). In illustrated example, the load linked function, when executed will read memory data from the address &mylink, store the address in a designated load linked address register (e.g., register 730), and set a load linked bit (e.g., stored in the load linked bit register 735) to a value 1, indicating that the process intends to store a value at the address &mylink. In this example, the read memory data value is stored as a local variable tmp and incremented, although in other examples, the read memory data need not be used by the accessing code.

The inc_write function then calls the store_conditional function, which is used to encode a store conditional (SC) assembly instruction (instruction ID 13). In the illustrated example, the store conditional function, when executed will check the values of &link and the load linked bit. If the value of &link matches the value stored in the designated load linked address register, and the load linked bit value is set to one, then the store conditional function proceeds to store the incremented value (tmp++) to memory at the specified memory address, and return a zero (0x0) value as the status indicator value. On other hand, if neither condition is satisfied, then the store conditional instruction fails: the memory location is not written to, and the function returns a one (0x1) value as the status indicator value. In either case, the load linked register bit is set to zero.

Portions of the assembly code 1220 implement the functionality specified by the source code 1210. As shown, the code is split across two instruction blocks labeled link_1 and link_2. The load linked instruction is labeled with instruction ID 12 and the store conditional instruction is labeled with ID 13. The SC operation is not architecturally visible until the instruction block commits Thus, an arbitrary number of additional instructions in the instruction block link _1 can execute after the conditional store executes and loads the store queue with its operands. For example, the SUBI instruction 15 can execute to decrement val. In some examples, the assembly code will also include data for setting the instruction block header to set the block synchronization flag to prevent speculative execution or other processor behavior that might result in improper operation of the LL or SC instructions.

The second, subsequent instruction block, link_2 will be jumped to after all the dependencies are satisfied for the block link_1 and the block commits The commitment of block link_1 will include storing the status indicator value in register R8 and, if the conditions described above are satisfied, storing the data at the &mylink memory location. As shown, the second instruction block link_2 reads the status indicator from register R8 and sends the value to the predicate slots of instructions 1 and 2, so that the appropriate handling (in this example, retry of the store conditional, or call return) can be performed.

XIII. Example Method of Transforming Source and/or Object Code to Computer-Executable Code with Synchronized Memory Operations

FIG. 13 is a flowchart 1300 outlining an example method of generating computer executable code, as can be performed in certain examples of the disclosed technology. The outlined method can be performed using a general purpose processor or a block-based processor.

At process block 1310, computer-executable instructions are executed to analyze source and/or object code to identify synchronized memory operations specified by the code. For example, key words or library functions can be used in order to encode the synchronized memory operations. In other examples, a programmer provides assembly instructions for synchronized memory operations directly. In other examples, analysis of the control flow and operations specified in the code is performed in order to determine whether synchronized memory operations are present in the code. In some examples, atomic increment or decrement functions or statements are provided by programming languages that result in synchronized memory operation instructions being generated when compiled. In other examples, compiler pragmas, compiler intrinsics, or other programming constructions or models can be used by the compiler to determine whether synchronized memory instructions should be emitted. In some examples, libraries are provided that include synchronized memory instructions.

At process block 1320, the source and/or object code analyzed at process block 1310 is transformed into computer-executable code including computer-executable code for performing the identified synchronized memory operations. The computer-executable code generated when executed by a block-based processor will not create architecturally visible side effects until the instruction block is committed. For example, the computer-executable code can include load linked and store conditional instructions. The generated code can also include code for subsequent instruction blocks that can check a result value produced by one or more of the synchronized memory operations and handle the success or failure of the instruction appropriately. For example, if a store to a synchronized memory address fails, a subsequent instruction block can cause the code to reattempt the store instruction. Such instructions can be generated automatically by a compiler, based on compiler directives provided by a programmer, from provided code libraries, or using other suitable techniques for providing result handling in a subsequent instruction block.

At process block 1330, the computer-executable code generated in process block 1320 is stored in a computer-readable storage medium, for example, a memory, optical or magnetic disk, by sending instructions in a just-in-time fashion to a processor, or by transmitting the instructions via a computer network. The stored code can include at least one load linked instruction and/or at least one store conditional instruction. These instructions can be used when executed by a block-based processor to perform the synchronized memory operations specified in the code analyzed at process block 1310. For example, the computer-executable code saved at process block 1330 can be used to cause a block-based processor to perform the methods depicted above regarding FIG. 10 or FIG. 11. However, it should be readily understood that the computer-executable code can be used to perform other memory operations and synchronization operations in certain embodiments.

### XIV. Example Computing Environment

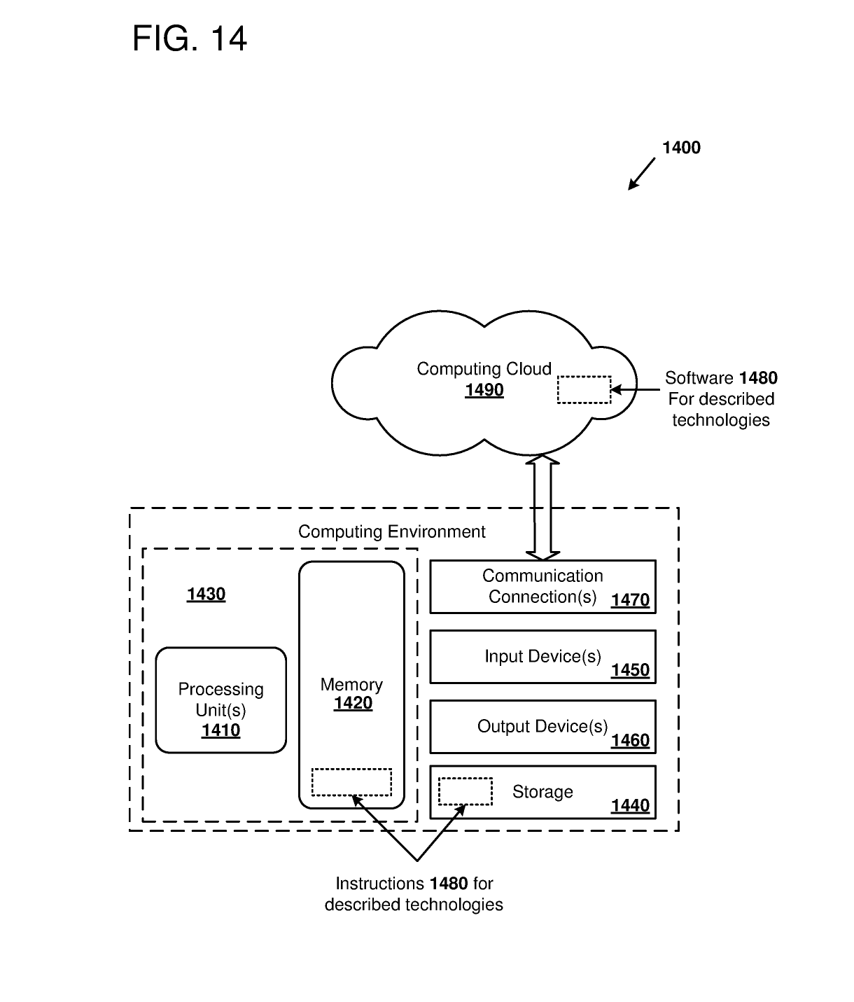

FIG. 14 illustrates a generalized example of a suitable computing environment 1400 in which described embodiments, techniques, and technologies, including configuring a block-based processor, can be implemented. For example, the computing environment 1400 can implement disclosed techniques for configuring a processor to perform disclosed memory operations for one or more instruction blocks, or compile code into computer-executable instructions for performing such operations, as described herein.

The computing environment 1400 is not intended to suggest any limitation as to scope of use or functionality of the technology, as the technology may be implemented in diverse general-purpose or special-purpose computing environments. For example, the disclosed technology may be implemented with other computer system configurations, including hand held devices, multi-processor systems, programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules (including executable instructions for block-based instruction blocks) may be located in both local and remote memory storage devices.

With reference to FIG. 14, the computing environment 1400 includes at least one block-based processing unit 1410 and memory 1420. In FIG. 14, this most basic configuration 1430 is included within a dashed line. The block-based processing unit 1410 executes computer-executable instructions and may be a real or a virtual processor. In a multi-processing system, multiple processing units execute computer-executable instructions to increase processing power and as such, multiple processors can be running simultaneously. The memory 1420 may be volatile memory (e.g., registers, cache, RAM), non-volatile memory (e.g., ROM, EEPROM, flash memory, etc.), or some combination of the two. The memory 1420 stores software 1480, images, and video that can, for example, implement the technologies described herein. A computing environment may have additional features. For example, the computing environment 1400 includes storage 1440, one or more input device(s) 1450, one or more output device(s) 1460, and one or more communication connection(s) 1470. An interconnection mechanism (not shown) such as a bus, a controller, or a network, interconnects the components of the computing environment 1400. Typically, operating system software (not shown) provides an operating environment for other software executing in the computing environment 1400, and coordinates activities of the components of the computing environment 1400.

The storage 1440 may be removable or non-removable, and includes magnetic disks, magnetic tapes or cassettes, CD-ROMs, CD-RWs, DVDs, or any other medium which can be used to store information and that can be accessed within the computing environment 1400. The storage 1440 stores instructions for the software 1480, plugin data, and messages, which can be used to implement technologies described herein.

The input device(s) 1450 may be a touch input device, such as a keyboard, keypad, mouse, touch screen display, pen, or trackball, a voice input device, a scanning device, or another device, that provides input to the computing environment 1400. For audio, the input device(s) 1450 may be a sound card or similar device that accepts audio input in analog or digital form, or a CD-ROM reader that provides audio samples to the computing environment 1400. The output device(s) 1460 may be a display, printer, speaker, CD-writer, or another device that provides output from the computing environment 1400.

The communication connection(s) 1470 enable communication over a communication medium (e.g., a connecting network) to another computing entity. The communication medium conveys information such as computer-executable instructions, compressed graphics information, video, or other data in a modulated data signal. The communication connection(s) 1470 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed methods. In a virtual host environment, the communication(s) connections can be a virtualized network connection provided by the virtual host.

Some embodiments of the disclosed methods can be performed using computer-executable instructions implementing all or a portion of the disclosed technology in a computing cloud 1490. For example, disclosed compilers and/or block-based-processor servers are located in the computing environment, or the disclosed compilers can be executed on servers located in the computing cloud 1490. In some examples, the disclosed compilers execute on traditional central processing units (e.g., RISC or CISC processors).

Computer-readable media are any available media that can be accessed within a computing environment 1400. By way of example, and not limitation, with the computing environment 1400, computer-readable media include memory 1420 and/or storage 1440. As should be readily understood, the term computer-readable storage media includes the media for data storage such as memory 1420 and storage 1440, and not transmission media such as modulated data signals.

### XV. Additional Examples of the Disclosed Technology

Additional examples of the disclosed subject matter are discussed herein in accordance with the examples discussed above. For example, aspects of the block-based processors discussed above regarding FIGS. 1, 2, and 7 can be used to implement these additional examples.

In some examples of the disclosed technology an apparatus includes one or more block-based processor cores coupled to a memory. At least one of the cores includes a control unit configured to issue one or more memory operations encoded in an instruction block allocated to the at least one core and to commit the core when execution of the instruction block is complete, a memory store queue configured to cache one or more operands for the one or more memory operations, where a result produced by performing the memory operations is not architecturally visible unless the instruction block is committed by the control unit, and a memory interface configured to store the cached operands in the memory responsive to the instruction block committing.

In some examples of such an apparatus, at least one of the memory operations is a store conditional instruction. In some examples, at least one of the memory operations is an unconditional store instruction or a load linked instruction. In some examples, the control unit is further configured to: observe a store operation performed by the memory interface to store the cached operands and generate a status indicator value indicating whether the store operation was successful. In some examples, the status indicator value is stored in a target specified by a store conditional instruction. In some examples, the target is an architecturally-visible register in a global or local register file. In some examples, at least one of the cores is further configured to, if the memory interface cannot store the cached operand, then flush the instruction block. In some examples, the apparatus is configured to automatically retry executing the flushed block. In some examples, an apparatus is configured to automatically retry a flushed block based in part on a configurable system policy. In some examples, one or more of the block-based processor cores are configured for multi-processor and/or multi-threaded operation. In some examples, the apparatus includes a load linked address register storing a memory address for a current synchronized memory operation and a load linked register storing data indicating whether a memory location associated with the memory address is currently linked to by a thread or process.

In some examples of the disclosed technology, a method of operating a block-based processor to execute an instruction block using a memory unit being coupled to the block-based processor includes executing a memory store instruction specified in the instruction block by storing one or more operands of the memory store instruction in a store queue of the block-based processor, generating a status indicator value indicating whether a memory operation specified by the memory store instruction was successful, and if the instruction block commits, attempting to perform a memory operation with the memory unit based on the operands stored in the store queue.

Some examples of the method further include, if the memory operation is successful, sending the status indicator value indicating success to a target operand specified by the memory store instruction. Some examples of the method further include, if the memory operation is not successful, then sending the status indicator value indicating failure to a target operand specified by the memory store instruction. In some examples the instruction block is a first instruction block, and the method further includes receiving the result data with a second instruction block via a global register and, based on the status indicator value indicating failure, causing the processor to re-execute the first instruction block. In some examples a result of attempting to perform the memory operation is not architecturally visible until the instruction block commits In some examples, the status value indicator is not architecturally visible until the instruction block commits In some examples, both the result and the status indicator value are not visible until the instruction block commits In some examples, the method further includes, after the executing the memory store instruction, executing one or more additional instructions specified in the instruction block, and after the executing the one or more additional instructions, committing the instruction block, the committing including writing the operands stored in the store queue to the memory unit.

In some examples, the memory store instruction is a store conditional instruction, and executing the store conditional instruction causes the processor to compare an input operand value to a value stored in a load linked address register, and if the values match, then perform the memory store operation. In some examples, the memory store instruction is a store conditional instruction, and executing the store conditional instruction causes the processor to evaluate a link value and based on the link value, then perform the memory store operation. In some examples, the memory store instruction is a store conditional instruction, executing the store conditional instruction causes the processor to compare an input operand value to a value stored in a load linked address register and to evaluate a link value. If both the input operand value matches the value stored in a load linked address register, and based on the link value, then the processor performs the memory store operation.

In some examples, the memory store instruction is any one of the following: store conditional, compare and swap, or test and set. In some examples, load linked or other complementary instructions are provided to setup synchronization using the memory store instruction.

In some examples the method includes, prior to issuing the memory store instruction, executing a load linked instruction that causes the processor to: read a data value from an address location in the memory unit, store the address location in the load linked address register, and set a value to indicate that the address location is linked.

In some examples of the disclosed technology, a method of generating instructions for a block-based processor includes analyzing source code and/or object code for an instruction block to identify one or more synchronized memory operations specified by the code and transforming the source code and/or object code into computer-executable code for the instruction block, the computer-executable code being executable by a block-based processor and including one or more instructions for performing the identified synchronized memory operations, and a status indicator value of the performing is not architecturally visible until the instruction block is committed by the block-based processor. In some example, a result of a memory operation is also not architecturally visible until the instruction block is committed. In some examples, both the status indicator value and the result are not architecturally visible until the instruction block is committed by the block-based processor. In some examples, the method further includes storing the computer-executable code in a computer-readable storage medium, wherein the stored instructions include at least one load linked instruction and at least one store conditional instruction. In some examples, the instruction block is a first instruction block, and the method further includes generating computer-executable code for a subsequent instruction block including instructions for checking the a status indicator value, and, if the value indicates a memory store operation did not complete, then re-executing the first instruction block or flushing the first instruction block.

In some examples, one or more computer-readable storage media store computer-readable instructions that when executed by a processor, cause the processor to perform any of the disclose methods. In some examples of the storage media, the processor is a block-based processor. In some examples of the storage media, the processor is an EDGE ISA processor.

In view of the many possible embodiments to which the principles of the disclosed subject matter may be applied, it should be recognized that the illustrated embodiments are only preferred examples and should not be taken as limiting the scope of the claims to those preferred examples. Rather, the scope of the claimed subject matter is defined by the following claims. We therefore claim as our invention all that comes within the scope of these claims.

We claim:

1. An apparatus comprising one or more block-based processor cores coupled to a memory, at least one of the cores comprising:
a control unit configured to issue one or more memory operations encoded in an instruction block allocated to the at least one core and to commit the core when execution of the instruction block is complete;
a memory store queue configured to cache one or more operands for the one or more memory operations, wherein a result produced by performing the memory operations is not architecturally visible unless the instruction block is committed by the control unit; and
a memory interface configured to store the cached operands in the memory responsive to the instruction block committing.

2. The apparatus of claim 1, wherein at least one of the memory operations is a store conditional instruction.

3. The apparatus of claim 1, wherein at least one of the memory operations is an unconditional store instruction or a load linked instruction.

4. The apparatus of claim 1, wherein the control unit is further configured to:
observe a store operation performed by the memory interface to store the cached operands and generate a status indicator value indicating whether the store operation was successful.

5. The apparatus of claim 4, wherein the status indicator value is stored in a target specified by a store conditional instruction.

6. The apparatus of claim 1, wherein at least one of the cores is further configured to, if the memory interface cannot store the cached operand, then flush the instruction block.

7. The apparatus of claim 1, wherein the block-based processor cores are configured for multi-processor and/or multi-threaded operation.

8. The apparatus of claim 1, further comprising a load linked address register storing a memory address for a current synchronized memory operation and a load linked register storing data indicating whether a memory location associated with the memory address is currently linked to by a thread or process.

9. A method of operating a block-based processor to execute an instruction block using a memory unit coupled to the block-based processor, the method comprising:
executing a memory store instruction specified in the instruction block by storing one or more operands of the memory store instruction in a store queue of the block-based processor;
generating a status indicator value indicating whether a memory operation specified by the memory store instruction was successful; and
if the instruction block commits, attempting to perform a memory operation with the memory unit based on the operands stored in the store queue.

10. The method of claim 9, further comprising, if the memory operation is successful, then sending the status indicator value indicating success to a target operand specified by the memory store instruction.

11. The method of claim 9, further comprising, if the memory operation is not successful, then sending the status indicator value indicating failure to a target operand specified by the memory store instruction.

12. The method of claim 11, wherein the instruction block is a first instruction block, and wherein the method further comprises:
receiving the result data with a second instruction block via a global register and, based on the status indicator value indicating failure, causing the processor to re-execute the first instruction block.

13. The method of claim 9, wherein a result of attempting to perform the memory operation is not architecturally visible until the instruction block commits

14. The method of claim 9, further comprising:
after the executing the memory store instruction, executing one or more additional instructions specified in the instruction block; and
after the executing the one or more additional instructions, committing the instruction block, the committing including writing the operands stored in the store queue to the memory unit.

15. The method of claim 9, wherein the memory store instruction is a store conditional instruction, and wherein executing the store conditional instruction causes the processor to compare an input operand value to a value stored in a load linked address register, and if the values match, then perform the memory store operation.

16. The method of claim 9, wherein the memory store instruction is a store conditional instruction, and wherein executing the store conditional instruction causes the processor to evaluate a link value and based on the link value, then perform the memory store operation.

17. The method of claim 16, further comprising, prior to issuing the memory store instruction, executing a load linked instruction that causes the processor to:
read a data value from an address location in the memory unit;
store the address location in the load linked address register; and
set a value to indicate that the address location is linked.

18. One or more computer-readable storage media storing computer-readable instructions that when executed by a block-based processor, cause the processor to perform a method, the computer-readable instructions comprising:
instructions for analyzing source code and/or object code for an instruction block to identify one or more synchronized memory operations specified by the code; and
instructions for transforming the source code and/or object code into computer-executable code for the instruction block, the computer-executable code being executable by a block-based processor and including one or more instructions for performing the identified synchronized memory operations, wherein a result of the performing is not architecturally visible until the instruction block is committed by the block-based processor.

19. The one or more computer-readable storage media of claim 18, further comprising instructions for storing the computer-executable code in a computer-readable storage medium, wherein the stored instructions include at least one load linked instruction and at least one store conditional instruction.

20. The one or more computer-readable storage media of claim 18, wherein the instruction block is a first instruction block, and wherein the computer-readable instructions further comprise:
instructions for a subsequent instruction block including instructions for checking the result, and, if the result indicates a memory store operation did not complete, then re-executing the first instruction block or flushing the first instruction block.
